(19) United States
(12) Patent Application Publication
(10) Pub. No.: US 2016/0025326 A1
(43) Pub. Date: Jan. 28, 2016

(54) SPARKLY CHILDRENS PRODUCTS

(71) Applicant: Sergei GONCHAR, Miami Beach, FL (US)

(72) Inventor: Sergei GONCHAR, Miami Beach, FL (US)

(21) Appl. No.: 14/811,400

(22) Filed: Jul. 28, 2015

Related U.S. Application Data
(60) Provisional application No. 62/030,011, filed on Jul. 28, 2014.
(60) Provisional application No. 62/046,821, filed on Sep. 5, 2014.

(51) Int. Cl. F21V 33/00; F21V 23/02; A47K 11/04; A47G 19/02; B65D 51/24

(52) U.S. Cl. CPC F21V 33/0012; A47G 19/025; B65D 51/245; A47K 11/04; F21V 23/02; A47G 2200/08

(57) ABSTRACT

Children's products comprising display elements.

### CROSS REFERENCE

This application claims the benefit of U.S. Provisional Application No. 62/030,011 filed Jul. 28, 2014 and U.S. Provisional Application No. 62/046,821 filed Sep. 5, 2014 which are herein incorporated by reference in their entirety.

### BACKGROUND OF THE INVENTION

Parents and caregivers often experience difficulties when teaching their children how to use products such as table utensils and toilets. Once children learn how to utilize these products, there may be further difficulty in encouraging children to use said products. Children may become bored with mundane tasks such as eating and using a toilet. Therefore, there are a number of products which function to facilitate learning while providing entertainment. This is usually accomplished by providing children's products which are colorful, with designs and shapes of interest to a child. While these children's products are appealing, sometimes they cannot compete with a child's interest in other distractions, for example, technologies which provide lights and are more interactive. Therefore, it would be beneficial to provide children's products with display elements such as lights, which can facilitate learning as well as entertain a child.

### SUMMARY OF THE INVENTION

In one aspect, provided herein are products comprising: (a) a platform comprising a top facing surface and a bottom facing surface; (b) one or more light generating elements visible on the top facing surface of the platform; (c) a control element for controlling a display of the one or more light generating elements on the top facing surface of the platform; and (d) a power source to power the display of the one or more light generating elements. In some embodiments, the platform comprises a hollow body defined by the top facing surface and the bottom facing surface; and provided that at least one or more of the one or more light generating elements is housed within the hollow body. In some embodiments, the display comprises an image, figure, symbol, letter, or any combination thereof. In some embodiments, the product further comprises one or more sound elements. In some embodiments, a unique light generating element is paired with a unique sound element to form a unique sensory pair. In some embodiments, the product comprises two or more light generating elements; and provided that one of the two or more light generating elements is visible on the top facing surface at a different time than another of the two or more light generating elements to provide a dynamic display. In some embodiments, the control element comprises an on position and an off position; and provided that the on position optionally comprises two or more configurations for displaying the one or more light generating elements at variable intensities. In some embodiments, the product further comprises one or more activation elements that correspond to each light generating element; provided that each activation element comprises a mechanical element having a first configuration and a second configuration; and provided that the display of the one or more light generating elements is customizable by positioning one or more of the activation elements from the first configuration to the second configuration. In some cases, the product is a plate and the platform comprises a central area that accommodates food and an outer rim; and one or more of the one or more light generating elements is visible on the top facing surface of the outer rim. In some cases, the product is a table. In some cases, the product is an easel. In some embodiments, the product further comprises a latch or other connecting element configured to attach the platform to a body. In some cases, the product is a high chair tray and the body is a high chair. In some cases, the product is a stroller tray and the body is a stroller.

In another aspect, provided herein are vessels comprising: (a) a hollow body defining an inner space for holding food; (b) one or more light generating elements; (c) a control element for controlling a display of the one or more light generating elements; and (d) a power source to power the display of the one or more light generating elements. In some embodiments, the vessel further comprises an outer rim, optionally attached to an outer edge of the hollow body; provided that the outer rim comprises at least one of the one or more light generating elements; and provided that the display of the one or more light generating elements is visible on the outer rim. In some embodiments, the vessel further comprises a lid, optionally attached to an outer edge of the hollow body; provided that the lid comprises at least one of the one or more light generating elements; and provided that the display of the one or more light generating elements is visible on the lid. In some embodiments, the lid comprises a spout, nipple or straw. In some cases, the vessel is a cup. In some cases, the vessel is a bowl. In some embodiments, the vessel further comprises one or more activation elements that correspond to each light generating element; provided that each activation element comprises a mechanical element having a first configuration and a second configuration; and provided that the display of the one or more light generating elements is customizable by positioning one or more of the activation elements from the first configuration to the second configuration. In some embodiments, the vessel further comprises one or more sound elements. In some embodiments, a unique light generating element is paired with a unique sound element to form a unique sensory pair. In some embodiments, the vessel comprises two or more light generating elements; and provided that one of the two or more light generating elements is visible at a different time than another of the two or more light generating elements to provide a dynamic display. In some embodiments, the control element comprises an on position and an off position; and provided that the on position optionally comprises two or more configurations for displaying the one or more light generating elements at variable intensities.

In another aspect, provided herein are utensils comprising (a) a top portion; (b) a handle comprising a light generating element; (c) a control element for controlling a display of the light generating element; and (d) a power source to display the light generating element. In some embodiments, the display comprises an image, figure, symbol, letter, or any combination thereof. In some embodiments, the utensil further comprises one or more sound elements. In some embodiments, a unique light generating element is paired with a unique sound element to form a unique sensory pair. In some embodiments, the utensil comprises two or more light generating elements; and provided that one of the two or more light generating elements is visible on the handle at a different time than another of the two or more light generating elements to provide a dynamic display. In some embodiments, the control element comprises an on position and an off position; and provided that the on position optionally comprises two or more configurations for displaying the one or more light generating elements at variable intensities. In some embodiments, the utensil further comprises one or more activation elements that correspond to each light generating element; provided that each activation element comprises a mechanical element having a first configuration and a second configuration; and provided that the display of the one or more light generating elements is customizable by positioning one or more of the activation elements from the first configuration to the second configuration. In some cases, the utensil is a spoon. In some cases, the utensil is a fork. In some cases, the utensil is a knife. In some cases, the utensil is a spork. In some cases, the utensil is a pen. In some cases, the utensil is a pencil. In some cases, the utensil is a paint brush.

In another aspect, provided herein are training toilets comprising (a) a seat having an opening for receiving bodily waste, the seat comprising a top facing surface, a toilet bowl facing surface, and an optional lid; (b) a toilet bowl positioned beneath the seat in contact with the toilet bowl facing surface of the seat, the toilet bowl comprising a hollow body defining an inner space for collecting a bodily waste; provided that the hollow body comprises a first surface in contact with the bodily waste and a second surface opposite the first surface; (c) one or more light generating elements visible on the second surface of the toilet bowel, the top facing surface of the seat, the optional lid, or a combination thereof; (d) one or more sound elements; (e) a control element for controlling a display of the one or more light generating elements; a sound emission from the one or more sound elements; or a combination thereof; and (f) a power source to power the display of the one or more light generating elements; the emission of the one or more sound elements; or a combination thereof. In some embodiments, the training toilet further comprises a display sensor; provided that at least one of the one or more light generating elements is activated for visualization by the display sensor. In some embodiments, the display sensor is configured to recognize the presence of a body on the top facing surface of the seat to activate display of the one or more light generating elements. In some embodiments, a unique light generating element is paired with a unique sound element to form a unique sensory pair. In some embodiments, the display comprises an image, figure, symbol, letter, or any combination thereof. In some embodiments, the utensil further comprises one or more sound elements. In some embodiments, a unique light generating element is paired with a unique sound element to form a unique sensory pair. In some embodiments, the training toilet comprises two or more light generating elements; and provided that one of the two or more light generating elements is displayed at a different time than another of the two or more light generating elements to provide a dynamic display. In some embodiments, the control element comprises an on position and an off position; and provided that the on position optionally comprises two or more configurations for displaying the one or more light generating elements at variable intensities. In some embodiments, the training toilet further comprises one or more activation elements that correspond to each light generating element; provided that each activation element comprises a mechanical element having a first configuration and a second configuration; and provided that the display of the one or more light generating elements is customizable by positioning one or more of the activation elements from the first configuration to the second configuration.

In another aspect, provided herein is a die comprising (a) a hollow casing having a plurality of sides; provided that one or more sides comprises one or more sensors; (b) an enclosed space within the hollow casing comprising one or more light generating elements configured to be activated by the one or more sensors, and one or more noise elements configured to be activated by the one or more sensors; provided that the activation comprises visualization of the one or more light generating elements. In some embodiments, the one or more sensors is configured to detect the side of the die opposite to the side of the die positioned on the surface; and provided that the one or more sensors activates a noise element descriptive of the side of the die opposite of the side positioned on the surface. In some embodiments, the die comprises six sides.

In another aspect, provided herein is a bag comprising (a) one or more compartments having a plurality of sides; (b) a handle; (c) one or more light generating elements visible on one or more of the plurality of sides; (d) a control element for controlling a display of the one or more light generating elements; and (e) a power source to display the one or more light generating elements. In some cases, the bag is a suitcase. In some cases, the bag further comprises a sound element. In some embodiments, the display comprises an image, figure, symbol, letter, or any combination thereof. In some embodiments, a unique light generating element is paired with a unique sound element to form a unique sensory pair. In some embodiments, the bag comprises two or more light generating elements; and provided that one of the two or more light generating elements is displayed at a different time than another of the two or more light generating elements to provide a dynamic display. In some embodiments, the control element comprises an on position and an off position; and provided that the on position optionally comprises two or more configurations for displaying the one or more light generating elements at variable intensities. In some embodiments, the bag further comprises one or more activation elements that correspond to each light generating element; provided that each activation element comprises a mechanical element having a first configuration and a second configuration; and provided that the display of the one or more light generating elements is customizable by positioning one or more of the activation elements from the first configuration to the second configuration.

In one aspect of the disclosure, provided herein is a plate comprising an area for accommodating food and a display element. In some embodiments, the area is a central area of the plate. In one feature, the plate comprises an outer rim, wherein the outer rim comprises a display element. In some embodiments, the outer rim is attached to an outer edge of the central area. In some embodiments, the outer rim is detachable. In some embodiments, the central area comprises a display element.

In some embodiments, the display element is a light generating element. As a non-limiting example, the light generating element is a light-emitting diode (LED). In some embodiments, the display element is powered by a battery. In one instance, the battery is housed in the outer rim. In one instance, the battery is housed in any area of the plate.

In some embodiments, the display element comprises a figure, symbol, letter, or any combination thereof. In some embodiments, the plate comprises a plurality of display elements. In one instance, the central comprises an image. In some embodiments, the image corresponds to the display element. In some embodiments, the plate further comprises a control element for controlling the operation of the display element.

In some embodiments, the plate is Bisphenol A (BPA) and/or Bisphenol S (BPS) free. In some embodiments, the central area is dishwasher safe. In some embodiments, the plate is dishwasher safe.

In another aspect of the disclosure, provided herein is a method of using a plate comprising: (a) providing a plate comprising an area for accommodating food and a display element activated by a control element; wherein the control element controls the operation of the display element; and (b) controlling the operation of the display element by manipulating the control element. In one instance, the central area of the plate includes a display element. In one instance, the rim includes a display element.

In one embodiment, the display element is a light generating element. As a non-limiting example, the light generating element is a light-emitting diode (LED). In one embodiment, the display element is powered by a battery. In one instance, the battery is housed in the outer rim. In one instance, the battery is housed in any area of the plate.

In one embodiment, the control element is a switch configured to be in an open or a closed position, provided that when the switch is in the open position visualization of the display element occurs, and provided that when the switch is in the closed position the display element is not visualized. Manipulating the control element, in one instance, comprises positioning the switch to the on or off position.

In one embodiment, the method further comprises entertaining an individual with the display element. In one embodiment, the method further comprises using the plate to hold food during a meal.

In one embodiment, an outer rim of the plate is detachably attached to a central area of the plate. One feature of the plate includes a rim comprising at least one tab configured to engage the central area of the plate for retaining the outer rim on the plate. Another feature of the plate includes a groove configured to engage with the at least one tab of the outer rim for retaining the rim on the plate.

In one embodiment, the plate is BPA and/or BPS free. In one embodiment, the central area is dishwasher safe. In one embodiment, the plate is dishwasher safe.

In one embodiment, the plate comprises a memory storage capability, including, for example, a memory storage device. A memory storage device includes, without limitation, universal serial bus (USB), hard drive (either internal or external), solid state drive (either internal or external), network attached storage, tape drive and zip drive.

In one embodiment, the plate comprises a data transmission capability, including, for example, wireless data transmission capability. A wireless data transmission capability includes Bluetooth or a Bluetooth adaptor.

In one aspect of the disclosure, provided herein is a vessel comprising (a) a hollow body defining an inner space for holding a food item, and (b) a display element. In one embodiment, the vessel further comprises an outer rim which is attached to an outer edge of the hollow body. In one instance, the rim is detachable. In one instance, the outer rim comprises the display element. In one instance, an outer wall of the hollow body comprises the display element.

In one embodiment, the hollow body comprises an image. One feature of the hollow body includes an image corresponding to the display element. In some instances, the food item is a beverage for drinking and the vessel is a cup. In one instance, the vessel is a bowl. In one embodiment, the vessel is a mug.

In one embodiment, the display element is a light generating element. As a non-limiting example, the light generating element is a light-emitting diode (LED). In one embodiment, the display element is powered by a battery. The battery may be housed in the outer rim. The battery may be housed in the hollow body. In one embodiment, the display element comprises a figure, symbol, letter, or any combination thereof. In one instance, the vessel comprises a plurality of display elements. In one embodiment, the vessel further comprises a control element for controlling the operation of the display element.

In one embodiment, the vessel is BPA and/or BPS free. In one embodiment, the hollow body is dishwasher safe. In one embodiment, the vessel is dishwasher safe.

In another aspect of the disclosure, provided herein is a method of using a vessel comprising (a) providing a vessel comprising a display element, a control element, and a hollow body defining an inner space for holding a food item; wherein the display element is activated by a control element; wherein the control element controls the operation of the display element; and (b) controlling the operation of the display element by manipulating the control element.

In one embodiment, the vessel further comprises an outer rim which is attached to an outer edge of the hollow body. In one instance, the rim is detachable. In one instance, the outer rim comprises the display element. In one instance, an outer wall of the hollow body comprises the display element.

In one embodiment, the hollow body comprises an image. In one instance, the image corresponds to the display element. In one instance, the food item is a beverage for drinking and the vessel is a cup. In one instance, the vessel is a bowl.

In one embodiment, the display element is a light generating element. As a non-limiting example, the light generating element is a light-emitting diode (LED). In one embodiment, the display element is powered by a battery. In one instance, the battery is housed in the outer rim. In one instance, the battery is housed in the hollow body. In one embodiment, the display element comprises a figure, symbol, letter, or any combination thereof. In one instance, the vessel comprises a plurality of display elements. In one embodiment, the vessel further comprises a control element for controlling the operation of the display element.

In one embodiment, the vessel is BPA and/or BPS free. In one embodiment, the hollow body is dishwasher safe. In one embodiment, the vessel is dishwasher safe.

In one embodiment, the control element is a switch configured to be in an open or a closed position, provided that when the switch is in the open position visualization of the display element occurs, and provided that when the switch is in the closed position the display element is not visualized. Manipulating the control element, in one instance, comprises positioning the switch to the on or off position.

In one embodiment, the method further comprises entertaining an individual with the display element. The method may further comprise using the vessel for holding a food item during a meal. In one instance, the method further comprises drinking a food item from the vessel during a meal. In one instance, the method further comprises eating a food item from the vessel during a meal.

In one embodiment, the rim comprises at least one tab configured to engage the hollow body for retaining the outer rim on the hollow body. One feature of the hollow body includes a groove configured to engage with the at least one tab of the outer rim for retaining the rim on the hollow body. In one embodiment, the method further comprises attaching the outer rim to the outer edge of the hollow body.

In one embodiment, the vessel comprises a memory storage capability, including, for example, a memory storage device. A memory storage device includes, without limitation, universal serial bus (USB), hard drive (either internal or external), solid state drive (either internal or external), network attached storage, tape drive and zip drive.

In one embodiment, the vessel comprises a data transmission capability, including, for example, wireless data transmission capability. A wireless data transmission capability includes Bluetooth or a Bluetooth adaptor.

In one aspect of the disclosure, provided herein is a utensil comprising (a) a top portion, and (b) a handle comprising a display element. In one embodiment, the top portion comprises metal.

In one embodiment, the utensil is a spoon. In one embodiment, the utensil is a fork. In one embodiment, the utensil is a knife. In one embodiment, the utensil is a spork.

In one embodiment, the top portion comprises an element for writing. In one instance, the utensil is a pen. In one instance, the utensil is a pencil. In one instance, the utensil is a paint brush.

In one embodiment, the display element is a light generating element. As a non-limiting example, the light generating element is a light-emitting diode (LED). In one embodiment, the display element is powered by a battery. The battery may be housed in the handle. In one embodiment, the display element comprises a figure, symbol, letter, or any combination thereof. In one instance, the handle comprises a plurality of display elements. In one embodiment, the utensil further comprises a control element for controlling the operation of the display element. In one embodiment, the utensil is BPA and/or BPS free.

In another aspect of the disclosure, provided herein is a method of using a utensil comprising (a) providing a utensil comprising (i) a handle comprising a display element, and (ii) a top portion comprising an article; and (b) transferring at least a portion of the article from the top portion of the utensil to a body. As non-limiting examples, the utensil is a spoon, fork, spork, knife, pen, paintbrush, or toothbrush. In one instance, the article is a food item and the body a mouth of an individual. In one instance, the article is ink and the body a canvas for receiving ink, for example, paper. In one instance, the article is graphite and the body a canvas for receiving graphite, such as paper. In one instance, the article is paint and the body a canvas for receiving paint, such as paper.

In one embodiment, the display element is a light generating element. As a non-limiting example, the light generating element is a light-emitting diode (LED). In one embodiment, the display element is powered by a battery. The battery may be housed in the handle. In one embodiment, the display element comprises a figure, symbol, letter, or any combination thereof. In one instance, the utensil comprises a plurality of display elements. In one embodiment, the utensil further comprises a control element for controlling the operation of the display element.

In one embodiment, the utensil is BPA and/or BPS free. In one embodiment, the handle is dishwasher safe. In one embodiment, the utensil is dishwasher safe.

In one embodiment, the control element is a switch configured to be in an open or a closed position, provided that when the switch is in the open position visualization of the display element occurs, and provided that when the switch is in the closed position the display element is not visualized. Manipulating the control element, as a non-limiting example, comprises positioning the switch to the on or off position.

In one embodiment, the method further comprises entertaining an individual with the display element.

In one embodiment, the utensil comprises a memory storage capability, including, for example, a memory storage device. A memory storage device includes, without limitation, universal serial bus (USB), hard drive (either internal or external), solid state drive (either internal or external), network attached storage, tape drive and zip drive.

In one embodiment, the utensil comprises a data transmission capability, including, for example, wireless data transmission capability. A wireless data transmission capability includes Bluetooth or a Bluetooth adaptor.

In one aspect of the disclosure, provided herein is a cup comprising (a) a hollow body defining an inner space for holding a liquid comprising an outer edge, and (b) a lid attached to the outer edge of the hollow body comprising a display element. In one instance, the lid is detachable.

In one embodiment, the cup is a mug. In another embodiment, the mug comprises a lid having an opening for drinking. In another embodiment, the mug is a travel mug.

In one embodiment, the lid comprises a bite valve for selectively delivering liquid from the hollow body for consumption, wherein the bite valve comprises an open and a closed position. As a non-limiting example, the bite valve is opened by squeezing the bite valve using the mouth of an individual so that liquid is delivered to an individual from the hollow body. In one embodiment, the display element is activated by opening the bite valve.

In one embodiment, the cup is a bottle and the lid comprises a nipple. As a non-limiting example, the display element is activated by opening the nipple to release the liquid.

In one embodiment, the cup is a sippy cup and the lid comprises a spout for sipping.

In one embodiment, the hollow body comprises an image. In one instance, the image corresponds to the display element. In one embodiment, the display element is a light generating element. As a non-limiting example, the light generating element is a light-emitting diode (LED). In one embodiment, the display element is powered by a battery. The battery may be housed in the lid. The battery may be housed in the hollow body. In one embodiment, the display element comprises a figure, symbol, letter, or any combination thereof. In one instance, the cup comprises a plurality of display elements. In one embodiment, the cup further comprises a control element for controlling the operation of the display element.

In one embodiment, the cup is BPA and/or BPS free. In one embodiment, the hollow body is dishwasher safe. In one embodiment, the cup is dishwasher safe.

In one embodiment, the cup further comprises one or more handles. In one instance, the one or more handles comprises a display element.

In another aspect of the disclosure, provided herein is a method of using a cup comprising (a) providing a cup comprising a hollow body defining an inner space for holding a liquid comprising an outer edge; and (b) attaching to the outer edge of the cup a lid comprising a display element. In one embodiment, the method further comprises entertaining an individual with the display element.

In one embodiment, the display element is a light generating element. As a non-limiting example, the light generating element is a light-emitting diode (LED). In one embodiment, the display element is powered by a battery. The battery may be housed in the lid. The battery may be housed in the hollow body. In one embodiment, the display element comprises a figure, symbol, letter, or any combination thereof. In one instance, the cup comprises a plurality of display elements.

In one embodiment, the cup further comprises a control element for controlling the operation of the display element. As one feature of the cup, the control element is a switch configured to be in an open or a closed position, provided that when the switch is in the open position visualization of the display element occurs, and provided that when the switch is in the closed position the display element is not visualized.

In one embodiment, the method further comprises positioning the switch to the on or off position.

In one embodiment, the method further comprises entertaining an individual with the display element of the lid.

In one embodiment, the lid comprises at least one tab configured to engage the outer edge of the cup for retaining the rim on the cup. In one instance, the cup further comprises a groove configured to engage with the at least one tab of the lid for retaining the lid on the cup.

In one embodiment, the lid further comprises a bite valve having an open and a closed position. A non-limiting example of a method of using a cup includes opening the bite valve with a mouth of an individual to administer liquid from the cup to the mouth. In some instances, an open bite valve activates display of the display element.

In one embodiment, the cup comprises a memory storage capability, including, for example, a memory storage device. A memory storage device includes, without limitation, universal serial bus (USB), hard drive (either internal or external), solid state drive (either internal or external), network attached storage, tape drive and zip drive.

In one embodiment, the cup comprises a data transmission capability, including, for example, wireless data transmission capability. A wireless data transmission capability includes Bluetooth or a Bluetooth adaptor.

In one aspect of the disclosure, provided herein is a cup comprising (a) a hollow body defining an inner space for holding a liquid comprising a liquid facing surface and an outer facing surface; and (b) at least one handle connected to the outer facing surface of the hollow body; provided that the at least one handle comprises a display element. In one instance, at least one handle is detachable. In one instance, the hollow body comprises a display element.

In one embodiment, the cup is a mug. In another embodiment, the mug comprises a lid having an opening for drinking. In another embodiment, the mug is a travel mug.

In one embodiment, the hollow body comprises an image. In one instance, the image corresponds to the display element. In one embodiment, the display element is a light generating element. As a non-limiting example, the light generating element is a light-emitting diode (LED). In one embodiment, the display element is powered by a battery. The battery may be housed in the handle. The battery may be housed in the hollow body. In one embodiment, the display element comprises a figure, symbol, letter, or any combination thereof. In one instance, the cup comprises a plurality of display elements. In one embodiment, the cup further comprises a control element for controlling the operation of the display element.

In one embodiment, the cup is BPA and/or BPS free. In one embodiment, the hollow body is dishwasher safe. In one embodiment, the cup is dishwasher safe.

In one embodiment, the cup further comprises a lid attached to the hollow body, where the lid is or is not detachable. In one instance, the lid comprises a hole. In one embodiment, the cup further comprises a straw. In one embodiment, the hole is positioned on a raised portion of the lid. In one embodiment, the lid comprises a nipple and the cup is a bottle. In one embodiment, the hole is a spout for sipping and the cup is a sippy cup.

In another aspect of the disclosure, provided herein is a method of using a cup comprising (a) providing a cup comprising a hollow body defining an inner space for holding a liquid comprising a liquid facing surface and an outer facing surface; and (b) attaching to the outer facing surface of the cup one or more handles comprising a display element. The liquid is a beverage for drinking or eating.

In one embodiment, the hollow body comprises an image. In one instance, the image corresponds to the display element. In one embodiment, the display element is a light generating element. As a non-limiting example, the light generating element is a light-emitting diode (LED). In one embodiment, the display element is powered by a battery. The battery may be housed in the handle. The battery may be housed in the hollow body. In one embodiment, the display element comprises a figure, symbol, letter, or any combination thereof. In one embodiment, the cup comprises a plurality of display elements. In one embodiment, the cup is BPA and/or BPS free. In one embodiment, the hollow body is dishwasher safe. In one embodiment, the cup is dishwasher safe.

In one embodiment, the cup further comprises a lid attached to the hollow body, where the lid is or is not detachable. In one aspect, the lid comprises a hole. In one embodiment, the cup further comprises a straw. In one embodiment, the hole is positioned on a raised portion of the lid. In one embodiment, the lid comprises a nipple and the cup is a bottle. In one embodiment, the hole is a spout for sipping and the cup is a sippy cup.

In one embodiment, the cup further comprises a control element for controlling the operation of the display element. In one instance, the control element is a switch configured to be in an open or a closed position, provided that when the switch is in the open position visualization of the display element occurs, and provided that when the switch is in the closed position the display element is not visualized. In one instance, the method further comprises positioning the switch to the on or off position.

In one embodiment, the method further comprises entertaining an individual with the display element. In one embodiment, the method further comprises drinking a beverage from the cup.

In one embodiment, the cup comprises a memory storage capability, including, for example, a memory storage device. A memory storage device includes, without limitation, universal serial bus (USB), hard drive (either internal or external), solid state drive (either internal or external), network attached storage, tape drive and zip drive.

In one embodiment, the cup comprises a data transmission capability, including, for example, wireless data transmission capability. A wireless data transmission capability includes Bluetooth or a Bluetooth adaptor.

In one aspect of the disclosure, provided herein is a combination of products comprising two or more products configured for holding a food item; provided that at least one product comprises a display element.

In one embodiment, the combination comprises a plate comprising an area for accommodating food and a display element. In one embodiment, the combination comprises a vessel comprising a hollow body defining an inner space for holding food and a display element. In one embodiment, the combination comprises a utensil comprising a top portion configured for holding food, and a handle comprising a display element. In one embodiment, the combination comprises a cup comprising a hollow body defining an inner space for holding a beverage comprising an outer edge, and a lid attached to the outer edge of the hollow body comprising a display element. In one embodiment, the combination comprises a cup with handles comprising a hollow body defining an inner space for holding a beverage comprising a beverage facing surface and an outer facing surface, and at least one handle connected to the outer facing surface of the hollow body; provided that the at least one handle comprises a display element. In one embodiment, the combination of products are connected by Bluetooth.

In one aspect of the disclosure, provided herein is a platform comprising a surface having a top facing side and a bottom facing side; provided that the top facing side comprises a display element. In one instance, the platform further comprises a sound element.

In one embodiment, the surface comprises a latch configured to attach the platform onto a body. In one instance, the body is a tray of a high chair, wherein the platform is attached to the tray via the latch; provided that the bottom facing side of the platform surface is facing a top facing side of the tray.

In one embodiment, the bottom facing side of the surface comprises one or more legs. In one instance, the platform is a table.

In one embodiment, the platform comprises one or more outer sides. In one instance, the one or more sides are attached to one or more legs. In one embodiment, the platform is an easel.

In one embodiment, the top facing side of the surface comprises a plurality of display elements. In one instance, each display element is unique from the other display elements. In one embodiment, the surface comprises a plurality of sound elements. In one instance, each sound element is unique from the other sound elements. In one embodiment, each unique display element is paired with one unique sound element to form a unique sensory pair. In one instance, each sensory pair is activated by a separate control element. In one instance, each sensory pair is activated by the same control element. In one embodiment, the sound element of the sensory pair is descriptive of the display element of the sensory pair.

In one embodiment, the platform comprises an image. In one instance, the image corresponds to the display element. In one embodiment, the display element is a light generating element. As a non-limiting example, the light generating element is a light-emitting diode (LED). In one embodiment, the display element is powered by a battery. The battery may be housed anywhere in the platform. In one embodiment, the display element comprises a figure, symbol, letter, or any combination thereof. In one embodiment, the platform further comprises a control element for controlling the operation of the display element. In one embodiment, the platform is BPA and/or BPS free. In one embodiment, the platform is dishwasher safe.

In one embodiment, the top facing side of the surface is configured for drawing. In one embodiment, the top facing side of the surface is configured for holding food.

In another aspect of the disclosure, provided herein is a method of using a platform comprising (a) providing a platform comprising (i) a surface having a top facing side and a bottom facing side, provided that the top facing side comprises a display element, and (ii) a control element for controlling the operation of the display element; and (b) activating the display element.

In one embodiment, the control element is a switch configured to be in an open or a closed position, provided that when the switch is in the open position visualization of the display element occurs, and provided that when the switch is in the closed position the display element is not visualized. In one instance, the display element is activated when the switch is in an open position.

In one embodiment, the platform further comprises a sound element. The operation of the sound element in some instances, is controlled by the same control element which controls the operation of the display element. In one instance, the display element is paired with the sound element to form a sensory pair. In one instance, a plurality of display elements are paired with a plurality of sound elements forming a plurality of sensory pairs.

In one embodiment, the platform comprises an image. In one instance, the image corresponds to the display element. In one embodiment, the display element is a light generating element. As a non-limiting example, the light generating element is a light-emitting diode (LED). In one embodiment, the display element is powered by a battery. The battery may be housed anywhere in the platform. In one embodiment, the display element comprises a figure, symbol, letter, or any combination thereof. In one embodiment, the platform further comprises a control element for controlling the operation of the display element. In one embodiment, the platform is BPA and/or BPS free. In one embodiment, the platform is dishwasher safe.

In one embodiment, the platform further comprises a latch configured to attach the platform onto a body such as a tray of a high chair. In one instance, the method further comprises attaching the platform to a tray of a high chair via the latch.

In one embodiment, the method further comprises using the platform to hold food for an individual eating a meal.

In one embodiment, the platform further comprises one or more legs. In one instance, the platform is a table. In one instance, the platform is an easel.

In one embodiment, the method further comprises drawing on the top facing surface of the platform.

In one embodiment, the method further comprises positioning the switch to the on or off position. In one embodiment, the method further comprises entertaining an individual with the display element.

In one embodiment, the platform comprises a memory storage capability, including, for example, a memory storage device. A memory storage device includes, without limitation, universal serial bus (USB), hard drive (either internal or external), solid state drive (either internal or external), network attached storage, tape drive and zip drive.

In one embodiment, the platform comprises a data transmission capability, including, for example, wireless data transmission capability. A wireless data transmission capability includes Bluetooth or a Bluetooth adaptor.

In one aspect of the disclosure, provided herein is a training toilet comprising (a) a seat having an opening for receiving bodily waste comprising a top facing surface and a toilet bowl facing surface; (b) a toilet bowl attached to the seat comprising a hollow body defining an inner space for collecting a bodily waste; provided that the hollow body comprises a first surface in contact with the bodily waste and a second surface opposite the first surface; and (c) a display element activated by a display sensor. In one instance, the second surface of the toilet bowl comprises a display element. In one instance, the top facing surface of the seat comprises a display element.

In one embodiment, the toilet further comprises a lid having a top facing surface and a seat facing surface. In one instance, the lid comprises a display element.

In one embodiment, the display sensor is positioned on the top facing surface of the seat. In one instance, the display sensor is positioned on the lid. In one instance, the display sensor is positioned on the toilet bowl.

In one embodiment, the display sensor is configured to recognize the presence of a body on the top facing surface of the seat, for example a human body. In one embodiment, the seat is removably attached to the toilet bowl.

In one embodiment, the toilet further comprises a sound element or a plurality of sound elements. In one instance, the toilet further comprises a plurality of display elements. In one instance, each display element is unique from the other display elements. In one instance, each sound element is unique from the other sound elements. In one embodiment, each unique display element is paired with one unique sound element to form a unique sensory pair. In one instance, each sensory pair is activated by a separate control element or the same control element.

In one embodiment, the display element is a light generating element. As a non-limiting example, the light generating element is a light-emitting diode (LED). In some embodiments, the display element is powered by a battery. The display element may comprise a figure, symbol, letter, or any combination thereof.

In one embodiment, the toilet bowl is shaped into a figure. The figure may be an animal and/or a mascot. The figure may be a car. In one aspect, the figure is any shape so long as the toilet bowl is still functional for receiving waste.

In another aspect of the disclosure, provided herein is a method of using a training toilet comprising (a) providing a training toilet comprising (i) a seat having an opening for receiving bodily waste comprising a top facing surface and a toilet bowl facing surface, (ii) a toilet bowl attached to the seat comprising a hollow body defining an inner space for collecting a bodily waste and a second surface opposite the first surface, and (iii) a display element activated by a display sensor; and (b) seating an individual on the seat of the training toilet with the purpose of disposing waste from the individual into the bowl of the training toilet. In one instance, the second surface of the toilet bowl comprises a display element. In one instance, the top facing surface of the seat comprises a display element.

In one embodiment, the toilet further comprises a lid having a top facing surface and a seat facing surface. In one instance, the lid comprises a display element.

In one embodiment, the display sensor is positioned on the top facing surface of the seat. The display sensor may be positioned on the lid. The display sensor may be positioned on the toilet bowl.

In one embodiment, the display sensor is configured to recognize the presence of a body on the top facing surface of the seat, for example a human body.

In one embodiment, the seat is removably attached to the toilet bowl.

In one embodiment, the toilet further comprises a sound element or a plurality of sound elements. In one instance, the toilet further comprises a plurality of display elements. In one instance, each display element is unique from the other display elements. In one instance, each sound element is unique from the other sound elements. In one embodiment, each unique display element is paired with one unique sound element to form a unique sensory pair. In one instance, each sensory pair is activated by a separate control element or the same control element.

In one embodiment, the display element is a light generating element. As a non-limiting example, the light generating element is a light-emitting diode (LED). In one instance, the display element is powered by a battery. The display element may comprise a figure, symbol, letter, or any combination thereof.

In one embodiment, the toilet bowl is shaped into a figure. The figure may be an animal and/or a mascot. The figure may be a car. In one instance, the figure is any shape so long as the toilet bowl is still functional for receiving waste.

In one embodiment, the method further comprises entertaining an individual. The individual may be entertained while they are seated on the toilet. In one embodiment, the method further comprises utilizing the display element to encourage an individual to dispose waste into the toilet bowl.

In one embodiment, the toilet comprises a memory storage capability, including, for example, a memory storage device. A memory storage device includes, without limitation, universal serial bus (USB), hard drive (either internal or external), solid state drive (either internal or external), network attached storage, tape drive and zip drive.

In one embodiment, the toilet comprises a data transmission capability, including, for example, wireless data transmission capability. A wireless data transmission capability includes Bluetooth or a Bluetooth adaptor.

In one aspect of the disclosure, provided herein is a die comprising (a) a hollow casing having a plurality of sides; provided that one or more sides comprises one or more sensors; and (b) an enclosed space within the hollow casing comprising one or more display elements configured to be activated by the one or more sensors, and one or more noise elements configured to be activated by the one or more sensors.

In one embodiment, each side of the die is configured to be positioned on a surface, for example, the die is rolled and when it stops, any side of the die may face the surface on which the die stops. In one instance, the one or more sensors is configured to detect the side of the die opposite to the side of the die positioned on the surface. The side of the die opposite the side of the die positioned on the surface is the top facing side of the die. In one embodiment, the one or more sensors activates a noise element descriptive of the top facing side.

In one embodiment, the hollow casing has 6 sides. As non-limiting examples, the hollow casing comprises 4, 5, 6, 7, 8, 9, 10 or more sides. In one embodiment, at least one side of the die contains a figure. For example, the figure is a number and each side of the die comprises a different number.

In another aspect of the disclosure, provided herein is a method of using a die comprising (a) providing a die comprising (i) a hollow casing having a plurality of sides, provided that one or more sides comprises one or more sensors, and (ii) an enclosed space within the hollow casing comprising one or more display elements configured to be activated by the one or more sensors, and one or more noise elements configured to be activated by the one or more sensors; and (b) throwing the die so that one of the sides of the die lands on a surface. The side of the die which is positioned on the surface is the bottom facing side. The side of the die opposite the bottom facing side is the top facing side.

In one embodiment, the one or more sensors is configured to detect the top facing side of the die. In one instance, the one or more sensors activate a noise element descriptive of the top facing side of the die.

In one embodiment, the hollow casing has 6 sides. As non-limiting examples, the hollow casing comprises 4, 5, 6, 7, 8, 9, 10 or more sides. In one embodiment, at least one side of the die contains a figure. For example, the figure is a number and each side of the die comprises a different number.

In one embodiment, the method further comprises using the die to perform a step in a game. The step in a game may comprise rolling a die to display a figure. For example, the figure is a number and the number is the number of steps or positions a player of the game advances.

In one embodiment, the die comprises a memory storage capability, including, for example, a memory storage device. A memory storage device includes, without limitation, universal serial bus (USB), hard drive (either internal or external), solid state drive (either internal or external), network attached storage, tape drive and zip drive.

In one embodiment, the die comprises a data transmission capability, including, for example, wireless data transmission capability. A wireless data transmission capability includes Bluetooth or a Bluetooth adaptor.

In another aspect of the disclosure, provided herein is a highchair tray comprising (a) a surface having a top facing side and a bottom facing side, wherein the top facing side accommodates food, dining products, toys, or other objects; and (b) one or more display elements. In some embodiments, the highchair tray is one component.

In another aspect of the disclosure, provided herein is a stroller tray comprising (a) a surface having a top facing side and a bottom facing side, wherein the top facing side accommodates food, dining products, toys, or other objects; and (b) one or more display elements.

In another aspect of the disclosure, provided herein is a suitcase comprising (a) one or more compartments having a plurality of sides, (b) a handle, and (c) one or more display elements.

### BRIEF DESCRIPTION OF THE DRAWINGS

FIG. 1 a non-limiting schematic side-view of a plate containing a central area [1], an outer rim [2], and a base[4].

FIG. 2 a non-limiting schematic top-view of a plate with display elements [3] located in central area [1] and outer rim [2] of the food-facing surface

FIG. 3 a non-limiting schematic of the battery [5] within the base[4] of the plate.

FIG. 4A a non-limiting schematic side-view of a sippy cup [6], comprising a vessel [7], a handle [8], a lid [9] and a spout [10];

FIG. 4B &FIG. 4C a non-limiting schematic top-view of sippy cup [6], comprising a handle [8], a lid [9] with multiple display elements [3] and a spout [10].

FIG. 5 a non-limiting schematic of utensils comprising an eating surface [11] and a handle [12] with multiple display elements [3].

FIG. 6 a non-limiting schematic of a platform table comprising a top-facing side with one or more display elements [3], legs [14], and a control element [15].

FIG. 7 a non-limiting schematic side-view of a toilet [16] comprising a seat [17] with one or more display elements [3], a lid [18] with one or more display elements [3], additionally comprising one or more speakers [19].

FIG. 8 a non-limiting schematic of a die [20] comprising one or more display elements [3] and one or more sound elements.

FIG. 9 a non-limiting schematic of a stroller tray [23] comprising a top surface [22] with one or more display elements [3], a control element [15], and one or more latches [22].

FIG. 10 a non-limiting schematic of a suitcase[24] with one or more display elements [3].

### DETAILED DESCRIPTION OF THE INVENTION

In one aspect of the disclosure, provided herein are children's products comprising one or more display elements. In some embodiments, the display elements are configured to provide training support for the child learning to use the product. In some embodiments, the display elements are configured to encourage use of the product. In some embodiments, the display elements prompt a child to develop favorable associations with the product. In this manner, the child becomes more familiar with the product and is more likely to use it on a regular basis. In some embodiments, the display elements are configured to entertain a child during use, allowing the child to use the product or perform a task for a longer period of time. In some embodiments, the display elements provide educational support which may be unrelated to product use. In other or additional embodiments, a children's product as described is not limited to use by a child, for example, a children's product is configured for use by children, adolescents and/or adults. In various embodiments, a child is an exemplary embodiment of a person and specific mention of a child does not preclude use by adolescents and/or adults.

In some embodiments, the display element comprises one or more light generating elements, such as light-emitting diodes. The display element is configured to be positioned on any surface of the product, so long as a child is able to view the display element. In some embodiments, the display element comprises one or more shapes including, but not limited to, numbers, letters, animals, symbols, characters, and mascots. For instance, the product comprises 1, 2, 3, 4, 5, 6, 7, 8, 9, 10 or more display elements. In one instance, the product comprises from about 1 to about 3 display elements. In one instance, the product comprises from about 3 to about 5 display elements. In one instance, the user may select the display element, such that the user may control the design of the display element. For example, the user may control the design of the display element to display the child's name. In one instance, choosing the design of the display element creates a permanent display element. In another instance, choosing the design of the display element does not limit the user from subsequently choosing a different design of the display element. The one or more display elements may be related in a theme. For example, the display elements have a theme associated with a movie, book, TV show, sport, animal, holiday, or sports team. In another example, the display elements may have an educational theme such as numbers, nutrition, math, science, history, reading, anatomy, biology, or zoology. The display element is or is not detachable from the product.

In some embodiments, a display element of a product provided herein is customizable by a user. In some embodiments, provided herein are methods for customizing a display element of a product described herein. In some cases the product is a plate. In some cases the product is a utensil. In some cases the product is a vessel, such as a cup. In some cases the product is a platform, such as a table. In some cases the product is a tray, such as a stroller and/or high chair tray. In some cases the product is a toilet. In some cases the product is a die. In some cases the product is a puzzle. In some embodiments, a method for customizing a display element comprises (a) providing a product comprising one or more display elements and one or more activation elements; wherein one activation element corresponds to one display element; and wherein the activation element comprises a mechanical element in a first configuration; comprising a first configuration and a second configuration; and (b) positioning the mechanical element of the one or more activation elements to a second configuration; wherein the second configuration provides a visual display of the one or more corresponding display elements. In some embodiments, the product comprises a control element for displaying the one or more display elements, wherein the control element comprises an on position and an off position. In some embodiments, the visual display of the one or more display elements comprises positioning the control element in an on position.

In some embodiments, the light generating element is a light-emitting diode (LED). The LED is colored or white. In one instance, the LED is a phosphor-based LED. In one instance, the LED is an organic LED. In one instance, the LED is a quantum dot LED. In one instance, the LED is miniature with a low-current, standard, or ultra-high-output category. In some instances, the LED flashes. In some instances, the LED is bi-colored, tri-colored, or decorative multicolor. In an exemplary embodiment, the LED is a Class 1 LED product, being safe under all conditions of normal use. LEDs may be of any size so long as they fit within the child's product. In some embodiments, the product comprises anywhere from between about 1 to about 20,000 LED lights. In some instances, the LED has an operating temperature from about −40 to about 100° C. In some embodiments, the LED is used as a movement sensor, for example using infrared LEDs to detect movement of a user. In some embodiments, the LED is used as a touch sensor, where it can both detect touch and emit light. As non-limiting examples, the LED is powered by a battery, electricity, or solar energy.

In some embodiments, the light generating element is an incandescent light. In some instances, the light generating element is a luminescent light. Luminescent lighting includes, but is not limited to, fluorescent, photoluminescence (laser lamp), solid-state (LED bulb), cathodoluminescence (ESL bulb), and electroluminescent. In some instances, the light has additional properties, such as germicidal. In some instances, the light generating element is chemiluminescent and therefore does not require an external energy source. In some instances, the light generating element is a laser diode.

In some embodiments, the products further comprise one or more sound elements. In some instances, the light generating elements correlate to a sound element. For example, a light generating element comprising an image of the letter ‘A’ correlates to a sound element providing a sound of the letter ‘A’. In some instances, the sound element comprises a phrase, such as for encouragement, entertainment, or education. For example, an encouraging phrase is congratulatory. An entertaining phrase may be a common phrase from a cartoon character.

In some embodiments, the products further comprise one or more design elements. For example, a design element includes an image, such as an image of an animal. A design element may include a shape of a product which is of interest to a child, for example, a plate in the shape of a car or animal. The products provided herein are configured to comprise any shape while maintaining function. The shapes are functional, for example, they facilitate use by a child, and/or are for entertainment, for example, a handle of a spoon shaped as a car. The shapes include, but are not limited to, cars, boats, animals, and characters. For example, a design element includes ergonomic features, which facilitate the use of the product by a child. Additional design elements include size, such that they are readily usable by a child, yet do not have small parts which may pose a choking hazard. As another example, design elements include safety features, such as BPA and/or BPS free products which are used for eating. In some instance, safety features also include compartments for housing power units, such as batteries, which are secure and unavailable for children to open or reach. In some instances, design elements include conveniences, for example, the product in part or in whole is dishwasher or washing machine safe.

In some embodiments, the product further comprises one or more control elements. The control element controls the operation of a display element. In some instances, the control element further controls the operation of a sound element. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position.

In one aspect of the product, the control element further comprises a control sensor, where activation of the control sensor turns a display and/or sound element on or off. For example, the product is turned on using a control switch, but the display element is not visualized until activated upon by a display sensor. In some embodiments, a control sensor is a motion sensor.

In some embodiments, the products further comprise a volume control element, where activation of the volume control element increases or decreases the output from the product's one or more sound elements. For example, the product is turned on using a control switch, but the volume control element may be used to adjust the sound element's volume output.

The display elements and optional sound elements are powered by a power source. In some embodiments, the power source is a battery. In some embodiments, the power source is electrical. In some embodiments, the power source is solar. In some instances, the display element does not require an external power source.

In one aspect of the disclosure, provided herein are children's products comprising detachable components. The use of detachable components allows each product to be customizable. For example, a product is a rim comprising one or more display elements. The rim is configured to attach to a variety of plates, cups, bowls, or similarly shaped objects. In another example, a product is one or more handles comprising one or more display elements. The handles are configured to be attached to one or more types of cups, bottles, plates, trays, or any suitable product in need thereof.

Further provided herein are combinations of products which, in some instances, are used in together for training, educating, and/or entertaining a child. For example, these include dinnerware sets, where components include one or more of the following: plate, bowl, cup, bottle, high chair, high chair tray, placemat, cup handles, spoon, fork, spork, knife, chopsticks, and table. All items may be packaged together as a feeding/dining set. Items such as a plate may be configured to be held together for example, using a tray which is configured to hold the plate/bowl/cups/utensils as a unit. In some embodiments, a combination comprises one or more of an easel, writing utensil, dice, or training toilet. One or more products of the combination comprise a display element. In some instances, all products of the combination comprise display elements. In some embodiments, one or more products comprise display elements and one or more products do not comprise display elements.

The product further comprises, in various embodiments, memory storage capabilities, including, for example, memory storage devices. Memory storage devices, in some instances, are removable. Memory storage capabilities include ports for the connection of memory storage devices. A memory storage device includes, without limitation, universal serial bus (USB), hard drive (either internal or external), solid state drive (either internal or external), network attached storage, tape drive and zip drive, among others. In some embodiments, the memory storage device is connected to the product, for example, by ethernet, USB port, firewire, bluetooth, or serial connection.

A memory storage device, in some embodiments, provides instructions to the product, for example, instructions for providing visualization of a display element and/or instructions for activating a sound element. In some embodiments, a memory device is configured to comprise a plurality of different product instructions. In some embodiments, product instructions are pre-loaded onto a memory device. In other instances, product instructions are available for download from a computer and/or internet source. As an exemplary embodiment, a product, such as a dice, comprises a USB port connected to a USB. In this example, a user is able to remove the USB from the USB port, connect the USB to a computer, download a set of instructions on the USB drive from said computer, and then transfer the instructions to the product using the USB drive; wherein the instructions are descriptive for a specific use of the product. As a further illustration, a USB is configured for providing specific instructions to a dice which are necessary for successful use of the dice during an educational game. Specifically, the game is used to instruct a child how to read and the dice receives instructions from the USB for displaying letters or words on the die. In some implementations, the memory storage device stores user provided settings, with settings being customizable. For example, a toilet is programmed to recall the name of the user or a favorite story of the user. In some embodiments, the type of element displayed is customizable. For example, a display is customized to show a child's name and/or a desired image.

In various embodiments, the product comprises an interface for connecting the product to a power supply. As an exemplary embodiment, the product comprises a USB port which is configured to be connected to a power supply using a suitable USB cable. Examples of power supplies include batteries, computers, and electrical power supplies.

The product further comprises, in various embodiments, one or more methods and/or interfaces to connect the product to a media platform. Examples of media include, without limitation, televisions, computers, tablets, phones, and all devices capable of connecting to the internet. In many implementations, the media platform comprises or is operably connected to software. In additional embodiments, the product comprises an embedded computing system, e.g., central processing unit, to eliminate the need for an external connection to a computer. The connection to a media platform allows the user to interact with software designed for use with the product. As an example, a product is a toilet and the software provides a game or story about toilet training. As another example, a product is a toilet and the software tracks successful use of the toilet. As an addition illustration, the software provides a visual display on the toilet correlating with successful toilet use. The software may include motivational support for encouraging use of the product. In additional embodiments, the product comprises one or more methods and/or interfaces for connecting the product to another product. The connection may be physical or virtual. As a non-limiting example, a pen is connected to an easel. In this example, an easel may comprise a display, such as the alphabet. The easel is able to recognize a user successfully tracing over letters of the alphabet with a pen. Therefore, the interface, in some embodiments, provides an interaction with the user. The interface may also be used to register the product. As an exemplary embodiment, the product has Bluetooth capabilities which are useful to connect the product to a media platform.

The product further comprises, in various embodiments, data transmission capabilities, including, for example, a wireless data transmission capability. Wireless data transmission includes transmission using radio waves, such as short wavelength, ultra-high frequency (UHF) radio waves. Data transmission capabilities include embedded as well as non-embedded capabilities. As an example, a product comprises Bluetooth. As another example, a product comprises a Bluetooth adaptor, which is configured for use with Bluetooth.

Wireless data transmission is useful, in various instances, to connect a first product to one or more additional components in a system. Additional components include, without limitation, products which are used in combination with the first product and/or devices which are used to control one or more products of the system. As an example, a product is a die and a second product is a board game. A player of the board game activates a sensor on the board, which in turn provides a signal, via wireless transmission, to the die to display a specific symbol on each face of the die. As another example, a product is a cup (e.g., mug) and a device, such as a phone, is used to wirelessly transmit data to the cup. The transmitted data includes a program, or instructions, for warming the contents of the cup.

Wireless data transmission is useful, in various instances, to control a product provided herein. For example, a phone, application on a phone, computer, software on a computer, or remote control is used to provide instructions to a product. Instructions include, without limitation, turning on or off a display for visualization, turning on or off a sound element, controlling the type of display, and controlling the type of sound. In one embodiment, a product provided herein comprises one or more speakers configured to emit a sound. In an additional embodiment, the emission of sound through the speaker is controlled by a media device such as a phone or computer, provided that the product is connected to the media device by wireless data transmission, e.g., Bluetooth.

### Children's Dining Products

Provided herein are children's dinnerware products comprising one or more display elements. Dinnerware products include, but are not limited to, plates, bowls, cups (including sippy cups, bottles, cups with lids, cups with straws), spoons, forks, sporks, knifes, chop sticks, trays, placemats, high chairs, tables, and components and accessories thereof. Components include, but are not limited to, a handle, rim (e.g. for a plate, bowl, cup), and any component of a product disclosed herein which is removably attached from the remainder of the product. In some embodiments, the components include one or more display elements. Accessories include, but are not limited to, sleeves, lids, holders, toys, books, software, and any item which is configured to be used together with a children's product disclosed herein. In some embodiments, the accessory comprises one or more display elements. In some embodiments, the accessory does not comprise a display element. Further provided herein are products for the administration of food or medicine to a child, for example, spoons and syringes are used to administer medicine, candy, or baby food to a child. Any product, component, or accessory disclosed herein may be utilized with one or more additional products, components, or accessories disclosed herein. For example, a dinnerware set comprising a plate, cup, spoon, and fork, wherein each product comprises a at least one display element. Additionally, any product, component, or accessory disclosed herein may be utilized in combination with one or more additional products not comprising a display element. For example, a handle comprising at least one display element is combined with a cup not comprising a display element.

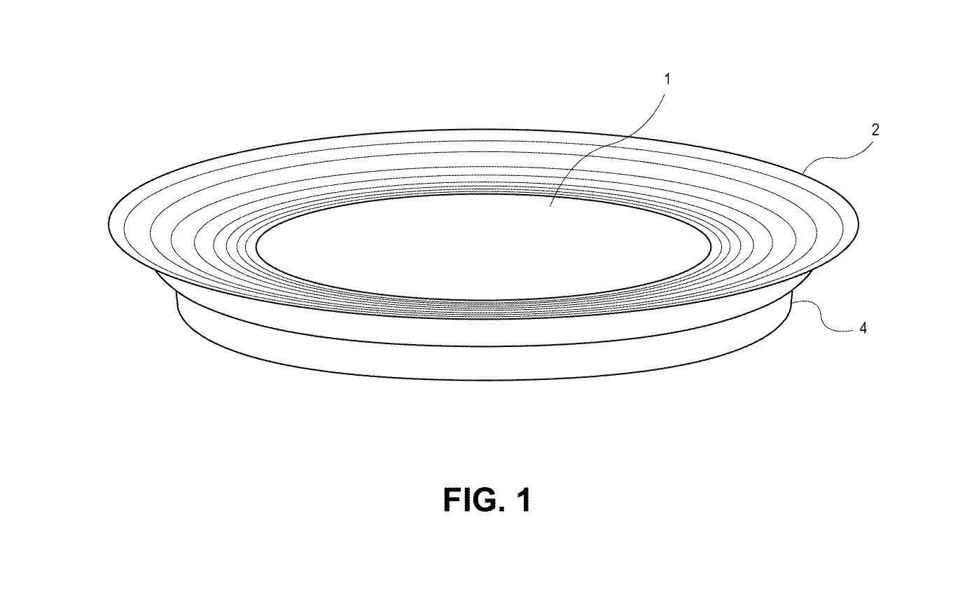

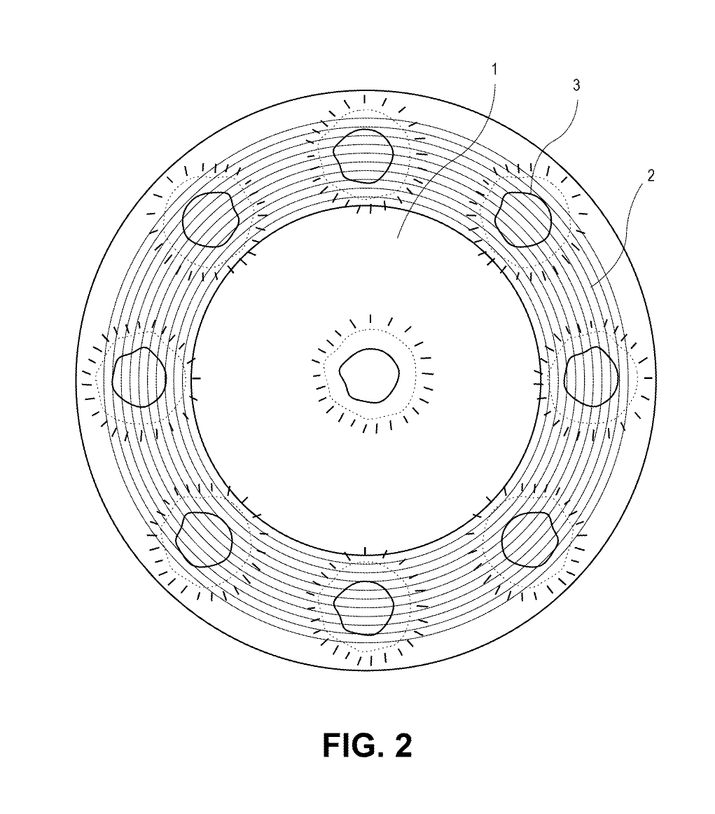

The dining products provided herein comprise one or more display elements and one or more surfaces for accommodating food. The surface for accommodating food, functioning to hold one or more items of food, wherein items of food include dry and liquid food (e.g., beverages, soups, baby food, wet cereals). The surface for accommodating food functions to hold one or more items containing food, for example, a baby food jar or a box of crackers. FIG. 1 illustrates a product comprising surface [1] for accommodating food. The outer rim [2] of the plate optionally provides a surface for accommodating food. The surface for accommodating food, in some instances, further comprises one or more display elements, as exemplified by the plate in FIG. 2. The plate embodied in FIG. 2 comprises an outer rim comprising a plurality of lights [3] as display elements. The plurality of lights in this embodiment are displayed by the visualization of a different light or subset of lights at a different time then one or other lights on the plate. This provides a display that is not static, i.e. one or more elements of the light display are visualized at a different time than another. Provided herein, in various aspects, are display elements that are not static. In some instances, the surface for accommodating food does not comprise one or more display elements. In some instances, the surface for accommodating food on a plate includes the central area of a plate. The plate is able to accommodate dry or liquid food anywhere on the top surface of the plate. The surface for accommodating food on a bowl includes a hollow body defining an inner space of the bowl. The bowl is able to accommodate dry food, such as crackers, or liquid food, such as cereal with milk or pureed baby food, in the hollow body of the bowl. The surface for accommodating food on a sippy cup, cup, or bottle includes a hollow body defining an inner space of the cup. The sippy cup, cup, or bottle accommodates liquids such as milk or juice in the hollow body. The surface for accommodating food on a utensil such as a spoon, fork, spork, knife, or chop stick includes the top portion of the utensil. The surface for accommodating food on a tray, placemat, or table includes the top surface of the tray, placemat, or table. The top portion of a tray, placemat, high chair, or table is able to hold food such as crackers, or hold one or more items containing food, for example, a yogurt cup.

The display element is displayed on any surface of the product, including the surface for accommodating food, or any component of a product. For example, a plate comprises one or more display elements on the surface of the plate, so that while a child is eating and removing food from the plate, the display elements become increasingly visible. In another example, a plate comprises one or more display elements on an outer rim of the plate, wherein if food is placed in the central are of the plate, one or more display elements are visible on the outer rim of the plate during the meal. In some instances, the plate comprises one or more areas, wherein one or more areas comprise display elements and one or more additional areas accommodate food. For example, the plate comprises a central area for accommodating food and a detachable rim, wherein the detachable rim comprises one or more display elements. In one instance, one or more sides of a plate comprise one or more display elements.

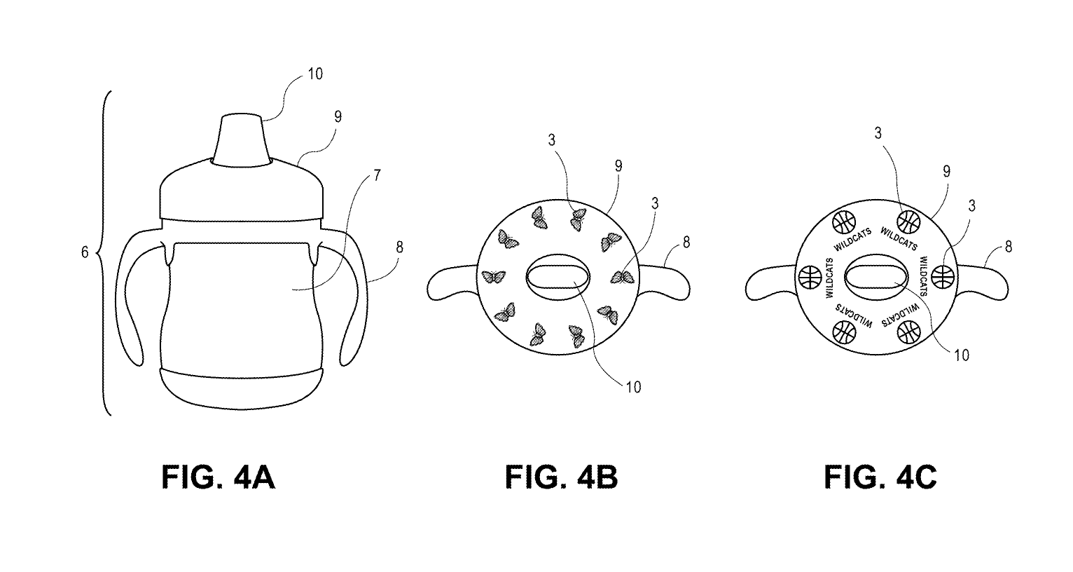

The display element is displayed on any surface of a bowl or cup. A bowl or cup comprises a hollow body defining an inner space for holding a food item. In some instances, the wall of the bowl or cup defining the inner space comprises one or more display elements. In some embodiments, the outside wall of the bowl or cup comprises one or more display elements. In some embodiments, the bowl or cup comprises a lid. In some embodiments, the lid includes a spout for sipping (e.g., sippy cup) or a nipple for drinking (e.g., bottle). In another embodiment, the lid includes a straw or bite valve, or a hole configured to hold a straw or bite valve. In some embodiments, the lid comprises one or more openings to facilitate removal of a dry food item, for example, cereal, from the hollow body of a bowl. In some embodiments, the lid includes one or more display elements. FIG. 4 is an exemplary cup comprising a lid comprising display elements [3] such as butterflies and logos [3]. In some instances, the bowl or cup further comprises one or more handles, where the one or more handles are permanently attached to the bowl or cup or are detachable. An embodiment of a cup with handles [8] is shown in FIG. 4. In some embodiments, the handles comprise one or more display elements. In some embodiments, the bowl or cup comprises an outer rim permanently attached to the bowl or cup. In some embodiments, the bowl or cup comprises a detachable rim. As a non-limiting example, the rim is configured to be attached to the outer edge of the hollow body. In some instances, the rim is configured to be attached to bottom of the hollow body. In some instances, the rim comprises one or more display elements.

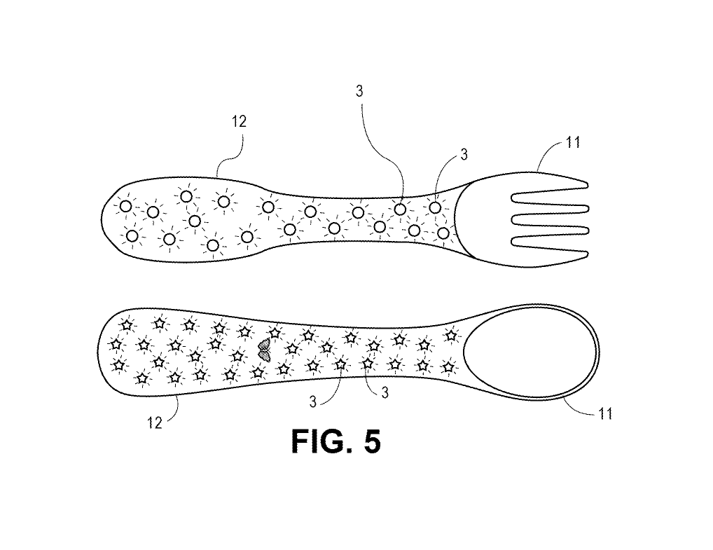

The display element is displayed on any surface of a utensil (e.g., spoon, fork, spork, knife, chop stick). In some instances, the utensil comprises a top portion for accommodating food and a handle. In some embodiments, the handle comprises one or more display elements, as exemplified by the spoon and fork shown in FIG. 5.

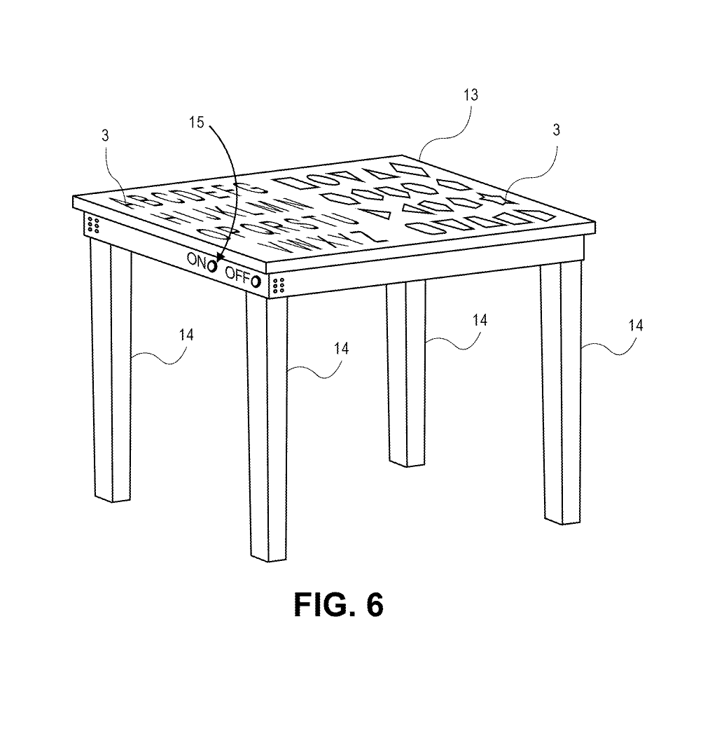

The display element is displayed on any surface of a tray, placemat, high chair, stroller tray or table. An embodiment of a table comprising display elements [3] is shown in FIG. 6. For example, the top facing surface of the tray, placemat, high chair, or table comprises one or more display elements. In some instances, the side facing surface comprises one or more display elements. In some instances, the food accommodating area comprises one or more display elements.

Each children's dining product comprising one or more display elements is configured for use by a child during eating. The display elements are configured teach and/or entertain a child during meal time. In some instances, the display elements assist in teaching a child how to use a dining product. In some instances, the display elements encourage use of the product. In some instances, the display elements provide educational support. In some instances, the display elements further entertain a child. In some embodiments, the children's dining products further comprise one or more sound elements. In some embodiments, the children's dining products further comprise one or more design elements.

### Plates

Provided herein is a plate comprising one or more display elements and one or more surfaces for accommodating food. The plate may be one component. In some embodiments, the plate comprises two or more components. In some instances, one component is a central area for accommodating food, and another component is a detachable outer rim. In some instances, a plate comprises a first component comprising a central area having a first surface for accommodating food and a second surface; and a second component attached to the second surface of the first component; wherein the second component comprises one or more display elements that are visible on the first surface of the first component of the plate. An embodiment of a plate comprising these features is shown in FIGS. 1-3. A plate provided herein comprises one or more display elements on any surface or component of the plate. In some embodiments, the display element is a light generating element. As a non-limiting example, the light generating element is a light-emitting diode. In some embodiments, the plate further comprises one or more sound elements. In some instances, a sound element corresponds to a display element. In some instances, the sound element is controlled by a volume control element.

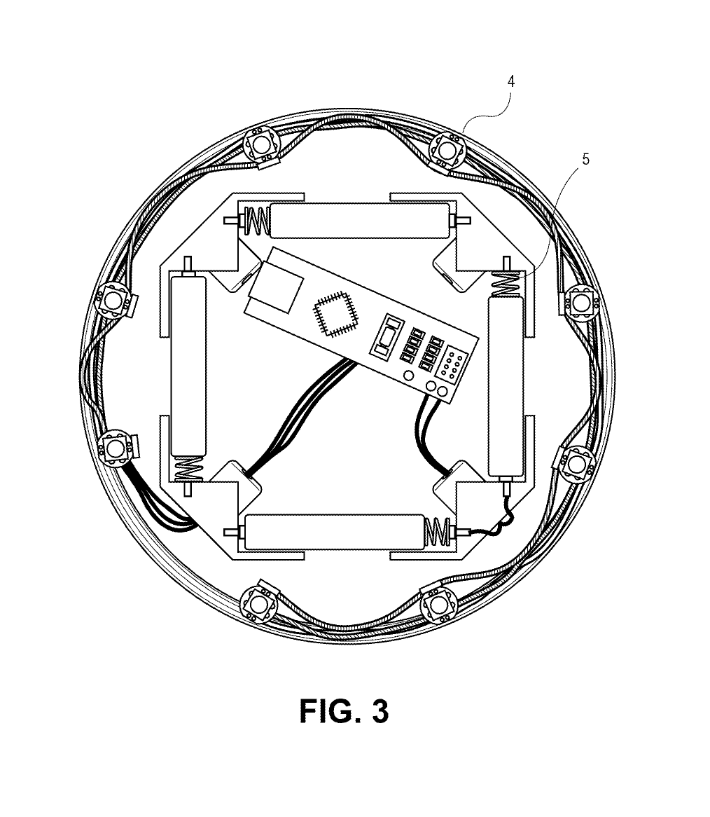

The plate further comprises a power source for powering the display of the display element. As a non-limiting example, the power source is a battery, as embodied by element [5] shown in FIG. 3. The battery may be housed at the base of the plate, e.g., the side of the plate opposite the food facing surface. The battery may be housed at an outer rim of the plate. The battery may be positioned so that a child is not able to remove said battery. In some instances, the battery further provides power for one or more sound elements.

The plate further comprises one or more control elements for displaying one or more display elements. In some instances, the control element provides the display element access to a power source. In some embodiments, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, an intermediate position selectively displays one or more display elements. In some embodiments, intermediate positions adjust the intensity of visualization of the display element. In some embodiments, the control switch further controls the release of one or more sound elements by moving the switch to an open, closed, or an optional intermediate position. In some instances, the plate comprises one or more switches for controlling one or more display elements, and one or more switches for controlling one or more sound elements. In some instances, one control switch controls both display and sound elements.

The plate further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The plate, in various embodiments, has memory storage capabilities. As a non-limiting example, the plate comprises or is operably connected to a memory storage device, such as, for example, a USB. In additional embodiments, the plate comprises an interface for connecting the plate to a media platform. A media platform includes, without limitation, television, computer, tablet, phone, and any device capable of connecting to the internet. A media platform may include software configured for use with the plate. In other embodiments, the plate comprises an interface for connecting the plate to another product provided herein. In additional manifestations, the plate comprises an interface for connecting the plate to a power supply.

The plate, in various embodiments, has wireless data transmission capabilities. As a non-limiting example, the plate comprises Bluetooth or a Bluetooth adaptor. In some embodiments, a plate is connected to a media platform by Bluetooth. In some embodiments, the plate is connected to another product provided herein via Bluetooth.

In some embodiments, the plate further comprises one or more design elements. As a non-limiting example, a design element includes images portrayed on the plate which are not light generating elements. In some instances, the images correspond to one or more display elements. In some instances, the design element includes the shape of the plate. For example, the plate is shaped as a character. The plate is configured to comprise any shape while maintaining function. The shape may be functional, i.e. it facilitates use by a child, and/or may be for entertainment. In some instances, the design element includes safety features. The central area for accommodating food, in some instances, is BPA f and/or BPS ree. In some embodiments, the entire plate, including the optional rim, is BPA and/or BPS free. The design element may include conveniences. The central area for accommodating food, in some instances, is dishwasher safe. In some embodiments, the entire plate, including the optional rim, is dishwasher safe. In some instances, a design element includes the composition of the plate. For example, the plate is comprised of materials suitable for child use during a meal. In some embodiments, one or more components of the plate comprises plastic, bamboo, metal, fiberglass, rubber, glass, silicone or combinations thereof. In some instances, the plate, or one or more components of the plate, comprises plastic. The optional outer rim, in some instances, comprises a stretchable material, such as rubber.

Further provided herein is a method of using a plate comprising one or more display elements. In some instances, the method comprises using the plate to feed a child during a meal. In some instances, the method comprises using the display element to provide a child encouragement during a meal. In some instances, the method comprises using the display element to provide educational support during a meal. In some instances, the method comprises using the display element to provide entertainment.

A method of using a plate provided herein includes, providing a plate comprising a surface for accommodating food, one or more display elements, and one or more control elements; and controlling the operation of the display element by manipulating the control element. In some instances, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method of using a plate further comprises attaching a component to the plate. In some instances, the component is an outer rim. The outer rim may be attached to an outer edge of the plate. In some embodiments, the outer rim comprises one or more display elements. In some embodiments, the outer rim is stretchable so that it fits tightly along the outer edge of the plate. The outer rim may attach to the base of the plate, opposite the food facing surface. In some instances, the outer rim comprises at least one tab configured to engage a plate and retain the outer rim on the plate. In some instances, the plate comprises a groove configured to engage with the at least one tab of the outer rim and retain the rim on the plate.

In some embodiments, the method further comprises using one or more additional products in combination with the plate. In some instances, the one or more additional products comprise one or more display elements. In some instances, additional products comprise one or more sound elements. Additional products include, for example, utensils, cups, and accessories. In some embodiments, an accessory is a book which correlates with the display and/or design elements of the plate. In some embodiments, an accessory is an application or software program performed on a computer such as a cell phone or tablet. For example, the application is a game about eating vegetables.

### Vessels

Provided herein is a vessel comprising (a) a hollow body defining an inner space for accommodating food, wherein the hollow body comprises an inner surface and an outer surface; and (b) one or more display elements. In some embodiments, a vessel is a bowl or a cup. A cup includes any vessel configured for drinking a beverage, including, for example, a sippy cup, cup with a lid, cup with a straw, cup with a bite valve, and bottle. In another embodiment, a vessel includes a mug, without or without a lid. In some embodiments, the vessel is one component. In some embodiments, the vessel comprises two or more components. In some instances, one component is a hollow body for accommodating food, and another component is a lid. In some embodiments, the lid includes, but is not limited to, a spout, straw, bite valve, opening, and nipple. An embodiment of a vessel comprising a spout [10] is shown in FIG. 4A. In some embodiments, the vessel comprises one or more handles. In some embodiments, the one or more handles are components of the vessel. In some embodiments, the one or more handles are removably attached to the vessel. In some embodiments, the vessel comprises an outer rim. The vessel comprises one or more display elements on any surface or component of the vessel. An embodiment of a vessel comprising display elements [3] on a lid [9] is shown in FIGS. 4B and 4C. In some embodiments, the display element is a light generating element. In a non-limiting example, the light generating element is a light-emitting diode. In some instances, the vessel further comprises one or more sound elements. In some instances, a sound element corresponds to a display element.

The vessel further comprises a power source for powering the display of the display element. In some embodiments, the power source is a battery. The battery may be housed at the outer surface or at the base of the vessel, e.g., the side of the vessel opposite the food facing surface. The battery may be housed in a handle of the vessel. The battery may be housed in a lid of the vessel. The battery may be housed in an outer rim of the vessel. In some instances, the battery is positioned so that a child is not able to remove said battery. In some instances, the battery further provides power for one or more sound elements. In some instances, the sound element is controlled by a volume control element.

The vessel further comprises one or more control elements for displaying one or more display elements. In some embodiments, the control element provides the display element access to a power source. In some embodiments, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position. In some instances, the plate comprises one or more switches for controlling one or more display elements, and one or more switches for controlling one or more sound elements. In some instances, one control switch controls both display and sound elements. In some embodiments, the control element allows for the activation of one or more display elements. For example, the control switch is positioned in the on position, however visualization of the display element is not activated until a signal activates visualization. In some instances, a signal is a sensor, for example, a sensor configured to activate visualization of a display element when the sensor is triggered, if the control switch is in an open or intermediate position. Therefore, if a sensor is triggered while the control switch is in a closed position, visualization of a display element does not occur. In some embodiments, a sensor is a motion sensor.

The vessel further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The vessel, in various embodiments, has memory storage capabilities. As a non-limiting example, the vessel comprises or is operably connected to a memory storage device, such as, for example, a USB. In additional embodiments, the vessel comprises an interface for connecting the vessel to a media platform. A media platform includes, without limitation, television, computer, tablet, phone, and any device capable of connecting to the internet. A media platform may include software configured for use with the vessel. In other embodiments, the vessel comprises an interface for connecting the vessel to another product provided herein. In additional manifestations, the vessel comprises an interface for connecting the vessel to a power supply.

The vessel, in various embodiments, has wireless data transmission capabilities. As a non-limiting example, the vessel comprises Bluetooth or a Bluetooth adaptor. In some embodiments, a vessel is connected to a media platform by Bluetooth. In some embodiments, the vessel is connected to another product provided herein via Bluetooth.

In some embodiments, the vessel further comprises one or more design elements. As a non-limiting examples, design elements includes images portrayed on the vessel which are not light generating elements. In some instances, the images correspond to one or more display elements. In some instances, the design element includes the shape of the vessel. For example, the vessel is shaped as the head of an animal. The vessel is configured to comprise any shape while maintaining function. In some instances, the shape is functional, i.e. it facilitates use by a child, and/or the shape is for entertainment. In another example, the design element includes safety features. The inner space of the hollow body for accommodating food, in some instances, is BPA and/or BPS free. In some embodiments, the entire vessel, including the optional rim, lid, and/or handle is BPA and/or BPS free. The design element may include conveniences. The hollow body for accommodating food, in some instances, is dishwasher safe. In some embodiments, the entire vessel, including the optional rim, lid, and/or handle is dishwasher safe. Another example of a design element includes the composition of the vessel. In some instances, the vessel is comprised of materials suitable for child use during a meal. In some embodiments, one or more components of the vessel comprises plastic, bamboo, metal, fiberglass, rubber, glass, silicone or combinations thereof. In some instances, the vessel, or one or more components of the vessel, comprises plastic. The optional outer rim may comprise a stretchable material, such as rubber.

Further provided herein is a method of using a vessel comprising one or more display elements. In some embodiments, the method comprises using the vessel to feed a child during a meal. In some instances, the method comprises using the display element to provide a child encouragement during a meal. In some instances, the method comprises using the display element to provide educational support during a meal. In some instances, the method comprises using the display element to provide entertainment.

A method of using a vessel provided herein includes, (a) providing a vessel comprising a hollow body defining an inner space for accommodating food, wherein the hollow body comprises an inner surface and an outer surface, one or more display elements, and one or more control elements; and (b) controlling the operation of the display element by manipulating the control element. In a non-limiting example, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method of using a vessel further comprises attaching a component to the vessel. In some embodiments, the component is a lid. In some embodiments, the lid comprises one or more display elements. In some instances, the lid comprises a spout for dispensing liquid from the vessel by sipping on the spout. In some instances, the lid comprises a straw for dispensing liquid from the vessel by sucking on the straw. In some embodiments, dispensing liquid from the vessel activates visualization of a display element. In some instances, the lid comprises a bite valve comprising an open and a closed position. In some instances, the bite valve is opened by squeezing the bite valve, which may be accomplished using the mouth of a child. The bite valve is configured to selectively dispense liquid from the vessel depending on the position of the bite valve, wherein if the bite valve is in the open position, liquid is released from the vessel. In some instances, the release of liquid is facilitated by applying reverse pressure to, or sucking, the opened bite valve. In some embodiments, a display element is activated by opening the bite valve. In some embodiments, the lid comprises a nipple and the vessel is a bottle. In some instances, a display element is activated by opening the nipple to release the liquid from the vessel. In some embodiments, the lid comprises one or more openings configured to allow for the selective removal of a food item from the vessel. In some instances, a display element is activated by removing food from the vessel. In some instances, the lid comprises at least one tab configured to engage the vessel for retaining the lid on the vessel. In some instances, the vessel comprises a groove configured to engage with at least one tab of a lid for retaining the lid on the vessel. In some embodiments, the vessel comprises at least one tab configured to engage the lid for retaining the lid on the vessel. In some embodiments, the lid comprises a groove configured to engage with at least one tab of a vessel for retaining the lid on the vessel.

In some embodiments, one or more handles are attached to the vessel. In some embodiments, the one or more handles comprise one or more display elements. In some instances, the one or more handles are attached to an outer edge of a vessel. In some instances, the one or more handles are attached to the base of the vessel. In some instances, the one or more handles are attached to the side of the vessel. In some instances, the one or more handles are provided in a sleeve which envelops the vessel. In some instances, the one or more handles are attached to a top edge of the vessel. In some embodiments, one or more display elements are activated by triggering one or more areas of the handle, provided that the handle comprises a sensor. In some embodiments, a sensor is a motion sensor.

In some embodiments, an outer rim is attached to the vessel. In some embodiments, the outer rim is attached to an outer edge of the vessel. In some embodiments, the outer rim comprises one or more display elements. In some instances, the outer rim is stretchable so that it fits tightly along the outer edge of the vessel. In some instances, the outer rim functions as a sleeve to fit tightly along the sides of the vessel. In some instances, the outer rim attaches to the bottom of the vessel. In some instances, the outer rim comprises at least one tab configured to engage a vessel and for retaining the outer rim on the vessel. In some instances, the vessel comprises a groove configured to engage with the at least one tab of the outer rim and for retaining the rim on the vessel.

In some embodiments, the method further comprises using one or more additional products in combination with the vessel. In some instances, the one or more additional products comprise one or more display elements. In some instances, the one or more additional products comprise one or more sound elements. Additional products include, for example, utensils, plates, and accessories. In some embodiments, an accessory is a book which correlates to the display and/or design elements of the vessel. In some embodiments, an accessory is an application or software program performed on a computer such as a cell phone or tablet.

### Utensils

Provided herein are utensils comprising (a) one or more surfaces for accommodating food (top portion), (b) a handle, and (c) one or more display elements. A utensil includes, but is not limited to, a spoon, fork, spork, knife, spork, syringe, or chop stick. In some embodiments, the utensil is one component. In some embodiments, the utensil comprises two or more components. In some instances, one component is a top portion for accommodating food, and another component is a detachable handle. The utensil comprises one or more display elements on any surface or component of the utensil. Embodiments of utensils comprising display elements [3] are shown in FIG. 5. In some embodiments, the display element is a light generating element. As a non-limiting example, the light generating element is a light-emitting diode. In some instances, the utensil further comprises one or more sound elements. In some instances, a sound element corresponds to a display element.

The utensil further comprises a power source for powering the display of the display element. In some instances, the power source is a battery. The battery may be housed in the handles of the utensil. The battery may be positioned so that a child is not able to remove said battery. In some instances, the battery further provides power for one or more sound elements.

The utensil further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The utensil further comprises one or more control elements for displaying one or more display elements. In some embodiments, the control element provides the display element access to a power source. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position.

The utensil, in various embodiments, has memory storage capabilities. As a non-limiting example, the utensil comprises or is operably connected to a memory storage device, such as, for example, a USB. In additional embodiments, the utensil comprises an interface for connecting the utensil to a media platform. A media platform includes, without limitation, television, computer, tablet, phone, and any device capable of connecting to the internet. A media platform may include software configured for use with the utensil. In other embodiments, the utensil comprises an interface for connecting the utensil to another product provided herein. In additional manifestations, the utensil comprises an interface for connecting the utensil to a power supply.

The utensil, in various embodiments, has wireless data transmission capabilities. As a non-limiting example, the utensil comprises Bluetooth or a Bluetooth adaptor. In some embodiments, a utensil is connected to a media platform by Bluetooth. In some embodiments, the utensil is connected to another product provided herein via Bluetooth.

In some embodiments, the utensil further comprises one or more design elements. In some instances, a design element includes images portrayed on the utensil which are not light generating elements. In some instances, the images correspond to one or more display elements. For example, the design element is the shape of the utensil. For example, the handle is shaped as a car. The utensil is configured to comprise any shape while maintaining function. In some embodiments, the shape is functional, i.e. it facilitates use by a child, and/or is for entertainment. In some instances, the design element includes safety features. The top portion for accommodating food, in some instances, is BPA and/or BPS free. In some embodiments, the entire utensil, including the handle, is BPA and/or BPS free. In some instances, the design element includes conveniences. The top portion for accommodating food, in some instances, is dishwasher safe. In some embodiments, the entire utensil, including the handle, is dishwasher safe. In some instances, a design element includes the composition of the utensil. In some instances, the utensil is comprised of materials suitable for child use during a meal. In some embodiments, one or more components of the utensil comprises plastic, bamboo, metal, fiberglass, rubber, glass, silicone or combinations thereof. The utensil, or one or more components of the utensil, may comprise plastic. The utensil, or one or more components of the utensil may comprise metal.

Further provided herein is a method of using a utensil comprising one or more display elements. In some instances, the method comprises using the utensil to feed a child during a meal. In some instances, the method comprises using the display element to provide a child encouragement during a meal. In some instances, the method comprises using the display element to provide educational support during a meal. In some instances, the method comprises using the display element to provide entertainment.

A method of using a utensil provided herein includes, (a) providing a utensil comprising a surface for accommodating food (top portion), one or more display elements, and one or more control elements; and (b) controlling the operation of the display element by manipulating the control element. In some embodiments, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method of using a utensil further comprises attaching a component to the utensil. As a non-limiting example, the component is a handle and/or a handle accessory. A handle accessory may include a gripping device configured to assist holding by a young child. In some instances, the handle accessory comprises one or more display elements. In some instances, the handle accessory is stretchable so that it fits tightly along the outer edge of the utensil. In some instances, the handle comprises at least one tab configured to engage the handle of a utensil, for retaining the handle accessory on the utensil. In some instances, the handle comprises a groove configured to engage with the at least one tab of the handle accessory, for retaining the handle accessory on the utensil.

In some embodiments, the method further comprises using one or more additional products in combination with the utensil. In some instances, the one or more additional products comprise one or more display elements. In some instances, the one or more additional products comprise one or more sound elements. Additional products include, for example, plates, cups, and accessories. Accessories include medicine or candy, for example, a pre-filled syringe comprising medicine or a pre-filled spoon comprising candy. In some embodiments, an accessory is a book which correlates to the display and/or design elements of the utensil. In some embodiments, an accessory is an application or software performed on a computer such as a cell phone or tablet.

### Platforms

Provided herein are platforms comprising (a) a surface having a top facing side and a bottom facing side, wherein the top facing side accommodates food; and (b) one or more display elements. A platform includes, but is not limited to, a tray, tray cover, placemat, and table. In some embodiments, the platform is one component. In some embodiments, the platform comprises two or more components. In some embodiments, the platform comprises a surface and at least one latch, wherein the latch is configured to attach the platform onto a body. For example, the platform is a tray cover and the at least one latch is configured to attach the tray cover onto a body, such as a high chair. In some embodiments, the platform comprises a surface and one or more legs. In some instances, the legs are removably attached to the surface. In some embodiments, the platform is a tray, wherein the legs fold at the bottom facing side of the surface. In some instances, the tray further comprises one or more handles. In some embodiments, the platform is a table, wherein the legs hold the surface at an elevated level above the ground. In some instances, the table comprises 1, 2, 3, 4, 5, 6, 7, 8, or more legs. In some embodiments, the platform is a tray, wherein the tray is a component of a high chair. The platform comprises one or more display elements on any surface or component of the platform. In some embodiments, the display element is a light generating element. As a non-limiting example, the light generating element is a light-emitting diode. In some instances, the platform further comprises one or more sound elements. In some instances, a sound element corresponds to a display element.

The platform further comprises a power source for powering the display of the display element. As a non-limiting example, the power source is a battery. The battery may be housed at the bottom facing side of the surface. The battery may be housed in a leg, provided the platform is a tray or table. In some instances, the battery is positioned so that a child is not able to remove said battery. In some instances, the battery further provides power for one or more sound elements.

The platform further comprises one or more control elements for displaying one or more display elements. An embodiment of a platform table comprising a top-facing side with one or more display elements [3], legs [14] and a control element [15] is shown in FIG. 6. In some instances, the control element provides the display element access to a power source. In some embodiments, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position.

The platform further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The platform, in various embodiments, has memory storage capabilities. As a non-limiting example, the platform comprises or is operably connected to a memory storage device, such as, for example, a USB. In additional embodiments, the platform comprises an interface for connecting the platform to a media platform. A media platform includes, without limitation, television, computer, tablet, phone, and any device capable of connecting to the internet. A media platform may include software configured for use with the platform. In other embodiments, the platform comprises an interface for connecting the platform to another product provided herein. In additional manifestations, the platform comprises an interface for connecting the platform to a power supply.

The platform, in various embodiments, has wireless data transmission capabilities. As a non-limiting example, the platform comprises Bluetooth or a Bluetooth adaptor. In some embodiments, a platform is connected to a media platform by Bluetooth. In some embodiments, the platform is connected to another product provided herein via Bluetooth.

In some embodiments, the platform further comprises one or more design elements. In some instances, a design element includes images portrayed on the platform which are not light generating elements. The images may correspond to one or more display elements. In some instances, the design element includes the shape of the platform or a component of the platform. For example, the surface is shaped as character. The platform is configured to comprise any shape while maintaining function. In some instances, the shape is functional, i.e. it facilitates use by a child, and/or the shape is for entertainment. In some instances, the design element includes safety features. The surface for accommodating food, in some instances, is BPA and/or BPS free. In some embodiments, the entire platform, including the legs, is BPA and/or BPS free. The surface, in some instances, is lead free. In some embodiments, the entire platform, including the legs, is lead free. The design element may include conveniences. The surface for accommodating food, in some instances, is washable. In some embodiments, the entire platform, including the legs, is dishwasher safe. In some instances, a design element includes the composition of the platform. For example, the platform is comprised of materials suitable for child use. In some embodiments, one or more components of the platform comprises plastic, bamboo, metal, fiberglass, rubber, glass, silicone or combinations thereof. In some instances, the platform, or one or more components of the platform, comprises plastic. In some instances, the platform, or one or more components of the platform, comprises metal. In some instances, the platform, or one or more components of the platform comprises wood. The wood may be finished so as not to generate splinters in a child.

Further provided herein is a method of using a platform comprising one or more display elements. In some instances, the method comprises using the platform during a children's meal. In some instances, the method comprises using the display element to provide a child encouragement during a meal. In some instances, the method comprises using the display element to provide educational support during a meal. In some instances, the method comprises using the display element to provide entertainment.

A method of using a platform provided herein includes, providing a platform comprising a surface having a top facing side for accommodating food, one or more display elements, and one or more control elements; and controlling the operation of the display element by manipulating the control element. In some embodiments, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method of using a platform further comprises attaching a component to the platform. As non-limiting examples, the component includes a latch, leg, handle, or platform accessory. In some instances, the method of using a platform further comprises attaching a platform to a body. For example, a latch of the platform engages with the body of a high chair. In another embodiment, a platform engages with a body of a stroller. In some instances, the latch of a platform engages with the body of a table to secure the platform to the table.

In some embodiments, the method further comprises using one or more additional products in combination with the platform. In some instances, the one or more additional products comprise one or more display elements. In some instances, additional products comprise one or more sound elements. Additional products include, plates, cups, and accessories. In some embodiments, an accessory is a book which correlates to the display and/or design elements of the platform. In some embodiments, an accessory is an application or software performed on a computer such as a cell phone or a tablet.

### Dining Product Combinations

Provided herein are combinations of children's dinnerware products, wherein at least one dinnerware product or component thereof comprises one or more display elements. Components include, but are not limited to, rims, handles, latches, legs, lids, and accessories configured to be used in combination with a product disclosed herein. Product combinations include any components or accessories necessary to obtain or use a dining product comprising one or more display elements. As an example, product combinations comprise a plate comprising one or more display elements. As another example, product combinations comprise a vessel comprising one or more display elements. As another example, product combinations comprise a utensil comprising one or more display elements. As another example, product combinations comprise a platform comprising one or more display elements.

In some embodiments, the product combination comprise products used by a child during eating which do not comprise a display element. In some embodiments, the product combination comprises a product not comprising a display element and a component of a dining product which comprises a display element. For example, a product combination includes a plate not comprising a display element and a rim comprising a display element. The product combination may further include instructions for attaching the rim to the plate to create a plate comprising a display element.

In some embodiments, the products are synchronized and/or connected by Bluetooth. In additional embodiments, the combined products are connected to a media platform via Bluetooth.

In one embodiment, provided is a combination comprising a vessel and a lid, wherein either the vessel, the lid, or both the vessel and lid comprise one or more display elements. In an embodiment, the vessel is a mug and the lid is attachable to the rim of the mug. The combination is useful as a travel mug. The travel mug, in various implementations, comprises a connection capability (e.g., wireless such as Bluetooth) to one or more additional devices. In this instance, an additional device includes a charging or power device (e.g., car, wall, or USB charger) and media platform (e.g., cell phone, computer).

### Highchair Trays

Provided herein are highchair trays comprising (a) a surface having a top facing side and a bottom facing side, wherein the top facing side accommodates food, dining products, toys, or other objects; and (b) one or more display elements. In some embodiments, the highchair tray is one component. In some embodiments, the highchair tray comprises two or more components. In some instances, the highchair tray comprises a surface and at least one latch, wherein the latch is configured to attach the highchair tray onto a body. In some instances, the highchair tray further comprises one or more handles. The highchair tray comprises one or more display elements on any surface or component of the highchair tray. In some embodiments, the display element is a light generating element. As a non-limiting example, the light generating element is a light-emitting diode. In some instances, the highchair tray further comprises one or more sound elements. In some instances, a sound element corresponds to a display element.

The highchair tray further comprises a power source for powering the display of the display element. In some instances, the power source is a battery. The battery may be housed in the handle of the highchair tray. The battery may be positioned so that a child is not able to remove said battery. In some instances, the battery further provides power for one or more sound elements.

The highchair tray further comprises one or more control elements for displaying one or more display elements. In some embodiments, the control element provides the display element access to a power source. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position.

The highchair tray further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The highchair tray, in various embodiments, has memory storage capabilities. As a non-limiting example, the highchair tray comprises or is operably connected to a memory storage device, such as, for example, a USB. In additional embodiments, the highchair tray comprises an interface for connecting the highchair tray to a media platform. A media platform includes, without limitation, television, computer, tablet, phone, and any device capable of connecting to the internet. A media platform may include software configured for use with the highchair tray. In other embodiments, the highchair tray comprises an interface for connecting the highchair tray to another product provided herein. In additional manifestations, the highchair tray comprises an interface for connecting the highchair tray to a power supply.

The highchair tray, in various embodiments, has wireless data transmission capabilities. As a non-limiting example, the utensil comprises Bluetooth or a Bluetooth adaptor. In some embodiments, a highchair tray is connected to a media platform by Bluetooth. In some embodiments, the highchair tray is connected to another product provided herein via Bluetooth.

In some embodiments, the highchair tray further comprises one or more design elements. In some instances, a design element includes images portrayed on the highchair tray which are not light generating elements. In some instances, the images correspond to one or more display elements. For example, the design element is the shape of the highchair tray. For example, the highchair tray is shaped like a dolphin. The highchair tray is configured to comprise any shape while maintaining function. In some embodiments, the shape is functional, i.e. it facilitates use by a child, and/or is for entertainment. In some instances, the design element includes safety features. The top portion for accommodating food, dining products, toys, or other objects, in some instances, is BPA and/or BPS free. In some embodiments, the entire highchair tray, including any latches or handles, is BPA and/or BPS free. In some instances, the design element includes conveniences. The top portion for accommodating food, dining products, toys, or other objects, in some instances, is dishwasher safe. In some embodiments, the entire highchair tray, including the handle, is dishwasher safe. In some instances, a design element includes the composition of the highchair tray. In some instances, the utensil is comprised of materials suitable for child use during a meal. In some embodiments, one or more components of the highchair tray comprises plastic, bamboo, metal, fiberglass, rubber, glass, silicone or combinations thereof. The highchair tray, or one or more components of the highchair tray, may comprise plastic. The highchair tray, or one or more components of the highchair tray may comprise metal.

Further provided herein is a method of using a highchair tray comprising one or more display elements. In some instances, the method comprises using the highchair tray to feed a child during a meal. In some instances, the method comprises using the display element to provide a child encouragement during a meal. In some instances, the method comprises using the display element to provide educational support during a meal. In some instances, the method comprises using the display element to provide entertainment.

A method of using a highchair tray provided herein includes, (a) providing a highchair tray comprising a top facing side and a bottom facing side, wherein the top facing side accommodates food, dining products, toys, or other objects, one or more display elements, and one or more control elements; and (b) controlling the operation of the display element by manipulating the control element. In some embodiments, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method of using a highchair tray further comprises attaching a component to the highchair tray. As a non-limiting example, the component is an accessory. An accessory may include an optionally attachable toy to capture the attention of a young child. In some instances, the accessory comprises one or more display elements. In some instances, the accessory comprises a suction cup configured to engage with the highchair tray, for retaining the handle accessory on the highchair tray. In some embodiments, the method further comprises using one or more additional products in combination with the highchair tray. In some instances, the one or more additional products comprise one or more display elements. In some instances, the one or more additional products comprise one or more sound elements. Additional products include, for example, plates, cups, and accessories. Accessories include toys, educational devices, mirrors, and the like. In some embodiments, an accessory is a book which correlates to the display and/or design elements of the highchair tray. In some embodiments, the highchair tray may be controlled by an application or software performed on a computer such as a cell phone or tablet.

### Children's Training Products

Provided herein are children's training products comprising one or more display elements. Training products include, but are not limited to, toilets, utensils, easels, dice, and components and accessories thereof. Utensils include writing utensils such as pens, pencils, crayons, markers, paint brushes, chalk; and toothbrushes. Components include, but are not limited to, lids, handles, legs, seats, and any component of a product disclosed herein. In some embodiments, components comprise one or more display elements. Accessories include but are not limited to, sleeves (e.g., cases for holding a product), books, software applications, toilet paper, board games, paint, toothpaste, paper, educational materials, toys, reward items, erasers, and any item which is capable of be used together with a product disclosed herein. In some embodiments, the component comprises a display element. In some embodiments, the accessory comprises one or more display elements. In some embodiments, the accessory does not comprise a display element. In some instances, the product, component, or accessory disclosed herein is able to be utilized with one or more additional products, components, or accessories disclosed herein. For example, a drawing set comprising markers and an easel, wherein each product comprises at least one display element. Additionally, the product, component, or accessory disclosed herein may be utilized in combination with one or more additional products not comprising a display element. For example, an easel comprising at least one display element and a set of markers not comprising a display element.

The products disclosed herein comprise one or more display elements. In some embodiments, the display element is positioned on any surface of the product, or any component of a product. In one example, a die comprises one or more display elements on any side of the die, wherein when the die is rolled, one or more display elements are visible on the top facing side of the die. In another example, a toilet comprising a toilet bowl comprises one or more display elements on the outer surface of the toilet bowl, to encourage a child to use the toilet. In some instances, the toilet comprises another component, such as a lid, which may comprise one or more display elements. The display element may be displayed on either a seat facing side or a top facing side of a lid. In some instances, the toilet comprises a seat comprising one or more display elements. In another example, an easel comprises one or more display elements on the front (or top) facing side, the back (or bottom) facing side, and/or one or more sides. In another example, a display element is positioned on any surface of a utensil. In some instances, the handle of a utensil comprises a display element.

Each children's training product comprising one or more display elements is configured for use by a child. In some embodiments, the display elements are configured to teach a child while using the product. In some embodiments, the display elements are configured to entertain a child while using the product. In some instances, the display elements assist in teaching children how to use a product, for example, a toilet. In some instances, the display elements encourage use of the product. In some instances, the display elements provide educational support. In some embodiments, the children's training products further comprise one or more sound elements. In some embodiments, the children's training products further comprise one or more design elements.

### Toilets

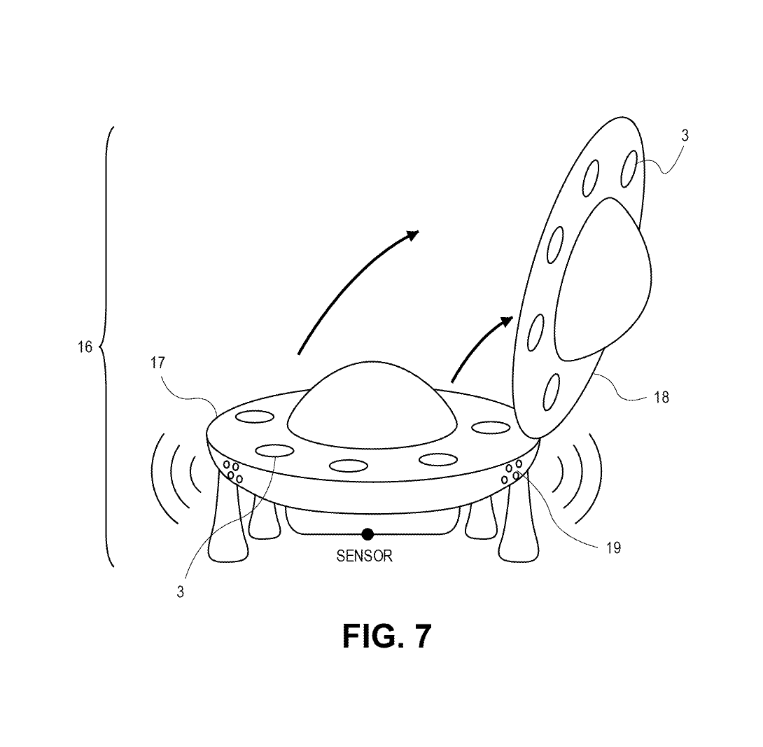

Provided herein is a toilet comprising (a) a seat having an opening for receiving bodily waste comprising a top facing surface and a toilet bowl facing surface; (b) a toilet bowl comprising a hollow body defining an inner space for collecting a bodily waste, provided that the hollow body comprises a waste facing surface and an outer facing surface opposite the waste facing surface; and (c) one or more display elements. In some embodiments, the toilet is one component. In some embodiments, the toilet comprises two or more components. In some instances, one component is a seat and another component is a toilet bowl. The seat may be removably attached to the toilet bowl. In some instances, the toilet comprises additional components, including but not limited to, a lid, handles, and accessories. Accessories include any item which may facilitate use of the toilet or may be used with the toilet, including, but not limited to, toilet paper holders, media holders, and book holders. A lid comprises a top facing surface and a seat facing surface. A lid may be removably attached to the toilet. In some embodiments, the top facing surface of the seat comprises a display element. In some embodiments, the outer facing surface of the toilet bowl comprises a display element. In some embodiments, the top facing surface of the lid comprises a display element. In some embodiments, the seat facing surface of the lid comprises a display element. In some embodiments, the display element is a light generating element. In some embodiments, the display element is a light-emitting diode. In some instances, the toilet further comprises one or more sound elements. In some instances, the sound element corresponds to a display element. An embodiment of a toilet [16] comprising a seat [17] with one or more display elements [3], a lid [18] with one or more display elements [3], and one or more speakers [19] is shown in FIG. 7.

The toilet further comprises a power source for powering the display of the display element. As a non-limiting example, the power source is a battery. The battery may be housed in the toilet bowl. The battery may be housed in the seat. The battery may be housed in a lid. The battery may be housed in the handle. In some instances, the battery is positioned so that a child is not able to remove said battery. In some instances, the battery further provides power for one or more sound elements.

The toilet further comprises one or more control elements for displaying one or more display elements. In some embodiments, the control element provides the display element access to a power source. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position. In some embodiments, the control element allows for the activation of one or more display elements. For example, the control switch is positioned in the on position; however, visualization of the display element is not activated until a signal activates visualization. In some instances, a signal is a sensor, for example, a sensor configured to activate visualization of a display element when the sensor is triggered, if the control switch is in an open or intermediate position. Therefore, if a sensor is triggered while the control switch is in a closed position, visualization of a display element does not occur.

In some embodiments, the toilet comprises a sensor for activating one or more display elements of the toilet. In some embodiments, the seat comprises a sensor, where a child sitting on the sensor activates a display element. In some embodiments, the sensor is motion activated, where when a child comes within a certain distance to the toilet, the sensor activates one or more display elements. In some instances, the motion activated sensor is housed on the seat, the toilet bowl, or lid. In some embodiments, the toilet bowl comprises a sensor, wherein if an object, e.g., bodily waste, is deposited into the toilet bowl, one or more display elements are activated.

In some embodiments, the toilet comprises one or more sound elements. In some embodiments, a sound element is configured to provide encouragement to a child using the toilet. In some embodiments, a sound element is congratulatory when a child successfully uses a toilet. In some embodiments, a sound element is entertaining. In some instances, a sound element includes sounds specific to the type of toilet. For example, a toilet shaped as a car, or having car themed display elements, includes sounds that cars make. In some embodiments, a sound element corresponds to a display element, forming a pair. The pair may be sensory pairs, wherein the same sensor activates both the display element and the sound element. In some instances, the display element has a different sensor than a sound element. In some embodiments, a pair comprising a display element and a sound element is controlled by the same control element. In some instances, a display element has a different control element than the sound element.

The toilet further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The toilet, in various embodiments, has memory storage capabilities. As a non-limiting example, the toilet comprises or is operably connected to a memory storage device, such as, for example, a USB. In additional embodiments, the toilet comprises an interface for connecting the toilet to a media platform. A media platform includes, without limitation, television, computer, tablet, phone, and any device capable of connecting to the internet. A media platform may include software configured for use with the toilet. In other embodiments, the toilet comprises an interface for connecting the toilet to another product provided herein. In additional manifestations, the toilet comprises an interface for connecting the toilet to a power supply.

The toilet, in various embodiments, has wireless data transmission capabilities. As a non-limiting example, the toilet comprises Bluetooth or a Bluetooth adaptor. In some embodiments, a toilet is connected to a media platform by Bluetooth. In some embodiments, the toilet is connected to another product provided herein via Bluetooth.

In some embodiments, the toilet further comprises one or more design elements. As an example, a design element includes images portrayed on the toilet which are not light generating elements. The images may correspond to one or more display elements. As another example, a design element includes the shape of the toilet. For example, the toilet is shaped as a car. The toilet is configured to comprise any shape while maintaining function. In some instances, the shape is functional, i.e. it facilitates use by a child, and/or the shape is for entertainment. The design element may include safety features. Safety features include additional components of the toilet, such as a booster seat configured to accommodate a small child or handles configured for a child to hold while using the toilet. The design element may include conveniences. In some instances, the toilet comprises convenient accessories, for example, liners to line the inner space of the toilet bowl to catch bodily waste, wherein the liners may be disposable or washable. The toilet may be comprised of materials suitable for child use. In some embodiments, one or more components of the toilet comprises plastic, bamboo, metal, fiberglass, rubber, glass, silicone or combinations thereof. In some instances, the toilet, or one or more components of the toilet, comprises plastic.

Further provided herein is a method of using a toilet comprising one or more display elements. In some embodiments, the method comprises using the toilet to “potty train” a child. In some embodiments, the method comprises using the display element to provide a child encouragement during training. In some embodiments, the method comprises using the display element to provide educational support during training. In some embodiments, the method comprises using the display element to provide entertainment.

A method of using a toilet provided herein includes, (a) providing a toilet comprising (i) a seat having an opening for receiving bodily waste comprising a top facing surface and a toilet bowl facing surface; (ii) a toilet bowl comprising a hollow body defining an inner space for collecting a bodily waste, provided that the hollow body comprises a waste facing surface and an outer facing surface opposite the waste facing surface; and (iii) one or more display elements; and (b) seating a child on the top facing surface of the seat with the purpose of eventually disposing waste from the child into the hollow body of the toilet bowl. In some embodiments, the toilet further comprises a control element. In some embodiments, the method further comprises controlling the operation of a display element by manipulating the control element. In some instances, manipulating the control element comprises positioning a control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element. In some embodiments, one control switch controls both display and sound elements.

In some embodiments, the method of using a toilet further comprises attaching a component to the toilet. In some embodiments, the component is a lid. In some embodiments, the lid comprises one or more display elements. In some embodiments, the component is a liner.

In some embodiments, the method further comprises using one or more additional products, components, or accessories in combination with the toilet comprising the one or more display elements. In some instances, additional products comprise one or more display elements. In some instances, additional products comprise one or more sound elements. In some embodiments, an accessory is a book which correlates to the display and/or design elements of the toilet. In some embodiments, an accessory is an application or software program performed on a computer such as a cell phone or a tablet. In some embodiments, a component is a media holder for holding a media device such as a cell phone or tablet.

### Dice

Provided herein is a die comprising (a) a hollow casing having a plurality of sides; (b) an enclosed space within the hollow casing; and (c) one or more display elements. In some embodiments, the display element is positioned on one or more sides of the hollow casing. In some embodiments, the display element is positioned within the enclosed space of the hollow casing. In some instances, the die comprises one or more sensors on one or more of the sides. In some instances, the die comprises one or more sensors within the enclosed space. In some embodiments, the die comprises one or more sound elements. In some instances, the sound element is positioned on a side of the hollow casing. In some instances, the sound element is positioned on an edge between two sides of a hollow casing. In some instances, the sound element is positioned on a corner between sides of a hollow casing. In some instances, the sound element is positioned within the enclosed space of the hollow casing.

The die further comprises a power source for powering the display of the display element. As a non-limiting example, the power source is a battery. The battery may be housed in the enclosed space within the hollow casing. In some instances, the battery further provides power for one or more sound elements.

In some embodiments, the die further comprises one or more control elements for visualizing one or more display elements. In some instances, the control element provides the display element access to a power source. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position. In some embodiments, the control element allows for the activation of one or more display elements. For example, the control switch is positioned in the on position, however visualization of the display element is not activated until a signal activates visualization. In some instances, a signal is a sensor, for example, a sensor configured to activate visualization of a display element when the sensor is triggered, if the control switch is in an open or intermediate position. Therefore, if a sensor is triggered while the control switch is in a closed position, visualization of a display element does not occur. In some embodiments, a sensor is a motion sensor.

In some embodiments, the die comprises one or more sound elements. In some embodiments, the sound element is descriptive. For example, a sound element indicates the side of die which is facing upwards, or is top facing. In some embodiments, a sound element is entertaining. In some instances, a sound element includes sounds specific to the type of die. For example, a die comprising numbers comprises a sound element which indicates one or more numbers on the die. In some embodiments, a sound element corresponds to a display element, forming a pair. In some instances, the pair is a sensory pair, wherein the same sensor activates both the display element and the sound element. In some instances, the display element has a different sensor than a sound element. In some embodiments, a pair comprising a display element and a sound element is controlled by the same control element. In some instances, a display element has a different control element than the sound element. In some embodiments, a sensor is a motion sensor.

The die further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

In some embodiments, the die comprises a sensor for activating one or more display elements of the die. In some embodiments, a side of a die comprises a sensor, wherein when a die is positioned on a surface; the sensor is configured to detect the side of the die opposite to the side of the die positioned on the surface, referred to as the top facing side. In some instances, the die comprises a sensor for activating a sound element. In some embodiments, a display element is activated by the same sensor as a sound element. In some embodiments, a display element is activated by a different sensor than a sound element. In some embodiments, a sensor is a motion sensor.

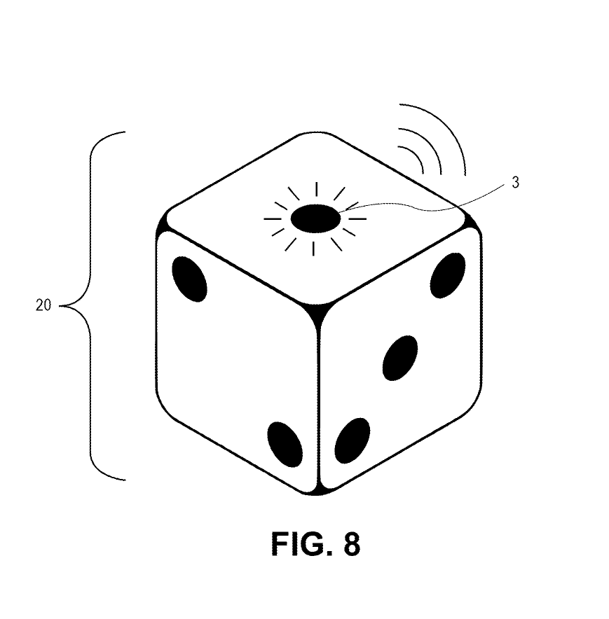

An embodiment of a die [20] comprising a display element [3] corresponding to a number on a face of the die is shown in FIG. 8. The die of FIG. 8 further comprises speakers for emitting a sound element as indicated by the curved lines shown in the figure. For the die exemplified in FIG. 8, the surface side of the die comprises a sensor (not shown) so that a sound corresponding to the top facing side of the die is activated, in this figure, the sound corresponds to the number one.

The die, in various embodiments, has memory storage capabilities. As a non-limiting example, the die comprises or is operably connected to a memory storage device, such as, for example, a USB. In additional embodiments, the die comprises an interface for connecting the die to a media platform. A media platform includes, without limitation, television, computer, tablet, phone, and any device capable of connecting to the internet. A media platform may include software configured for use with the die. In other embodiments, the die comprises an interface for connecting the die to another product provided herein. In additional manifestations, the die comprises an interface for connecting the die to a power supply.

The die, in various embodiments, has wireless data transmission capabilities. As a non-limiting example, the die comprises Bluetooth or a Bluetooth adaptor. In some embodiments, a die is connected to a media platform by Bluetooth. In some embodiments, the die is connected to another product provided herein via Bluetooth.

In some embodiments, the die comprises one more design elements. For example, a design element includes images portrayed on one or more sides of the hollow casing which are not light generating elements. In some instances, the images correspond to one or more display elements. In some instances, the design element includes the number of sides of the die. In some instances, the die comprises 6 sides. In some instances, the die comprises 4, 5, 6, 7, 8, 9, 10, 11, 12 or more sides. The sides are configured to comprise any shape while maintaining function of the die. In some instances, the design includes safety features, such as scaling the size of the die so that it does not produce a choking hazard for a child. Safety features include a die comprising soft edges. In some embodiments, one or more components of the die comprises plastic, bamboo, metal, fiberglass, rubber, glass, silicone or combinations thereof. In some instances, the die is comprised of plastic. In some instances, the die is comprised of fabric.

Further provided herein is a method of using a die comprising one or more display elements. For example, the method comprises using the die to play a game. In some instances, the method comprises using the die to educate a child on a subject. The subject may include letters, numbers, shapes, animals, and any figure which may be displayed on the surface of a die. In some instances, the method comprises using the die to entertain a child.

A method of using a die provided herein includes, (a) providing a die comprising (i) a hollow casing having a plurality of sides; (ii) an enclosed space within the hollow casing; and (ii) one or more display elements; and (b) rolling the die so that the die lands in a position where at least one side is facing up (top facing). In some instances, the die further comprises one or more sound elements. In some instances, the die further comprises a control element. In some embodiments, the method further comprises controlling the operation of a display element by manipulating the control element. In some instances, manipulating the control element comprises positioning a control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element. In some embodiments, one control switch controls both display and sound elements. In some embodiments, the die further comprises a sensor. In some embodiments, the display element is activated by a sensor. In some embodiments, the sound element is activated by a sensor. In some embodiments, the sensor activates a display and/or sound element when the die has landed face up. In some embodiments, the display element on the top facing surface is visualized. In some embodiments, a sound element descriptive of the top facing surface is released.

In some embodiments, the method further comprises using one or more additional products, components, or accessories in combination with the die. Additional products include games, wherein the die is used to advance a game. Additional products include educational materials or instructions on how to use the die in an educational manner. For example, the die is used to teach children numbers by displaying a number and the sound associated with the number.

### Stroller Trays

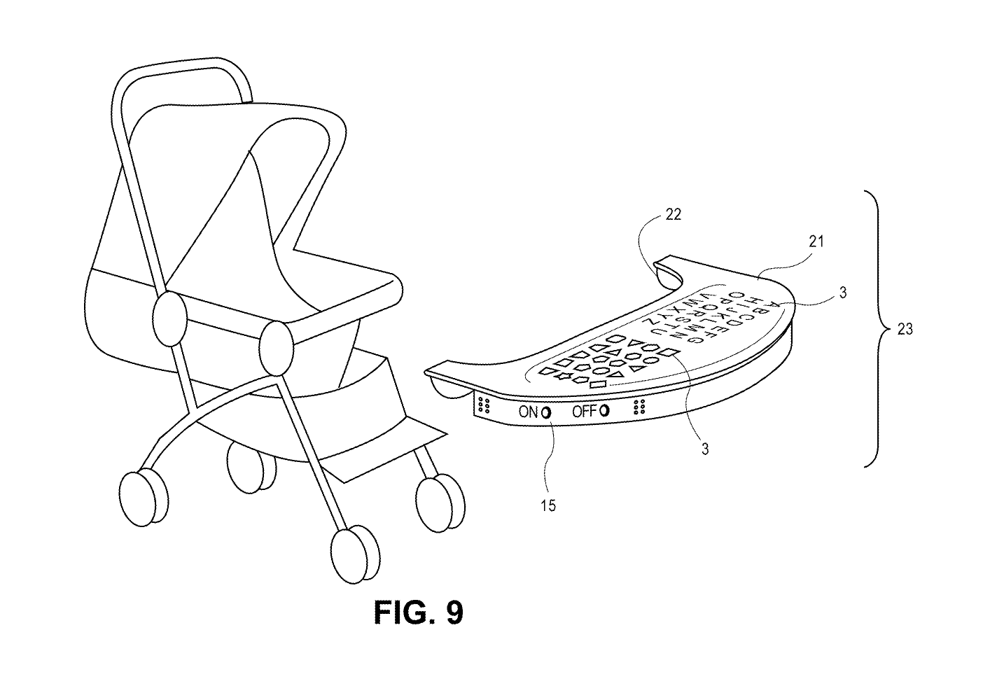

Provided herein are stroller trays comprising (a) a surface having a top facing side and a bottom facing side, wherein the top facing side accommodates food, dining products, toys, or other objects; and (b) one or more display elements. In some embodiments, the stroller tray is one component. In some embodiments, the stroller tray comprises two or more components. In some instances, the stroller tray comprises a surface and at least one latch, wherein the latch is configured to attach the stroller tray onto a body. In some instances, the stroller tray further comprises one or more handles. The stroller tray comprises one or more display elements on any surface or component of the stroller tray, as seen in FIG. 9. In some embodiments, the display element is a light generating element. As a non-limiting example, the light generating element is a light-emitting diode. In some instances, the stroller tray further comprises one or more sound elements. In some instances, a sound element corresponds to a display element.

The stroller tray further comprises a power source for powering the display of the display element. In some instances, the power source is a battery. The battery may be housed in the handle of the stroller tray. The battery may be positioned so that a child is not able to remove said battery. In some instances, the battery further provides power for one or more sound elements.

The stroller tray further comprises one or more control elements for displaying one or more display elements. In some embodiments, the control element provides the display element access to a power source. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position. An embodiment of a tray [23] comprising a top surface [22] with one or more display elements [3], a control element [15], and one or more latches [22] is shown in FIG. 9. The tray embodied in this figure is not limited to a tray for a stroller and includes features that are extended to a tray for a high chair. In some embodiments, the tray of FIG. 9 is a stroller tray. In some embodiments, the tray of FIG. 9 is a high chair tray.

The stroller tray further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The stroller tray, in various embodiments, has memory storage capabilities. As a non-limiting example, the stroller tray comprises or is operably connected to a memory storage device, such as, for example, a USB. In additional embodiments, the stroller tray comprises an interface for connecting the stroller tray to a media platform. A media platform includes, without limitation, television, computer, tablet, phone, and any device capable of connecting to the internet. A media platform may include software configured for use with the stroller tray. In other embodiments, the stroller tray comprises an interface for connecting the stroller tray to another product provided herein. In additional manifestations, the stroller tray comprises an interface for connecting the stroller tray to a power supply.

The stroller tray, in various embodiments, has wireless data transmission capabilities. As a non-limiting example, the stroller tray comprises Bluetooth or a Bluetooth adaptor. In some embodiments, a stroller tray is connected to a media platform by Bluetooth. In some embodiments, the stroller tray is connected to another product provided herein via Bluetooth.

In some embodiments, the stroller tray further comprises one or more design elements. In some instances, a design element includes images portrayed on the stroller tray which are not light generating elements. In some instances, the images correspond to one or more display elements. For example, the design element is the shape of the stroller tray. For example, the stroller tray is shaped like a dolphin. The stroller tray is configured to comprise any shape while maintaining function. In some embodiments, the shape is functional, i.e. it facilitates use by a child, and/or is for entertainment. In some instances, the design element includes safety features. The top portion for accommodating food, dining products, toys, or other objects, in some instances, is BPA and/or BPS free. In some embodiments, the entire stroller tray, including the latch and handle, is BPA and/or BPS free. In some instances, the design element includes conveniences. The top portion for accommodating food, in some instances, is dishwasher safe. In some embodiments, the entire stroller tray, including the latch and handle, is dishwasher safe. In some instances, a design element includes the composition of the stroller tray. In some instances, the stroller tray is comprised of materials suitable for child use during a meal. In some embodiments, one or more components of the stroller tray comprises plastic, bamboo, metal, fiberglass, rubber, glass, silicone or combinations thereof. The stroller tray, or one or more components of the stroller tray, may comprise plastic. The stroller tray, or one or more components of the stroller tray may comprise metal.

Further provided herein is a method of using a stroller tray comprising one or more display elements. In some instances, the method comprises using the stroller tray to feed a child during a meal. In some instances, the method comprises using the display element to provide a child encouragement during a long outing. In some instances, the method comprises using the display element to provide educational support during a long outing. In some instances, the method comprises using the display element to provide entertainment.

A method of using a stroller tray provided herein includes, (a) providing a surface having a top facing side and a bottom facing side, wherein the top facing side accommodates food, dining products, toys, or other objects; and (b) one or more display elements, and one or more control elements; and (c) controlling the operation of the display element by manipulating the control element. In some embodiments, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method of using a stroller tray further comprises attaching a component to the stroller tray. As a non-limiting example, the component is an accessory. An accessory may include an optionally attachable toy to capture the attention of a young child. In some instances, the accessory comprises one or more display elements. In some instances, the accessory comprises a suction cup configured to engage with the stroller tray, for retaining the accessory on the stroller tray.

In some embodiments, the method further comprises using one or more additional products in combination with the stroller tray. In some instances, the one or more additional products comprise one or more display elements. In some instances, the one or more additional products comprise one or more sound elements. Additional products include, for example, plates, cups, and accessories. Accessories include toys, educational devices, mirrors, and the like. In some embodiments, an accessory is a book which correlates to the display and/or design elements of the stroller tray. In some embodiments, the stroller tray may be controlled by an application or software performed on a computer such as a cell phone or tablet.

### Suitcases

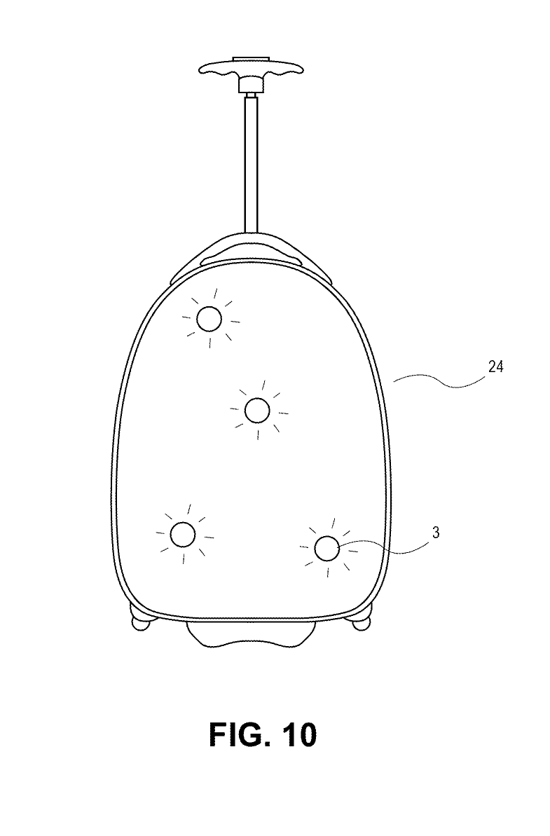

Provided herein are suitcases comprising (a) one or more compartments having a plurality of sides, (b) a handle, and (c) one or more display elements. A suitcase includes, but is not limited to, a bag, satchel, attaché, backpack, briefcase, satchel, tote, duffel, handbag, valise, or the like. In some embodiments, the suitcase is one component. In some embodiments, the suitcase comprises two or more components. In some instances, one component is a compartment for storing personal items, and another component is a detachable handle. The suitcase comprises one or more display elements on any surface or component of the suitcase. In some embodiments, the display element is a light generating element. As a non-limiting example, the light generating element is a light-emitting diode. In some instances, the suitcase further comprises one or more sound elements. In some instances, a sound element corresponds to a display element. An embodiment of a suitcase[24] comprising display elements [3] is shown in FIG. 10.

The suitcase further comprises a power source for powering the display of the display element. In some instances, the power source is a battery. The battery may be housed in the compartment of the suitcase. The battery may be positioned so that a child is not able to remove said battery. In some instances, the battery further provides power for one or more sound elements.

The suitcase further comprises one or more control elements for displaying one or more display elements. In some embodiments, the control element provides the display element access to a power source. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position.

The suitcase further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The suitcase, in various embodiments, has memory storage capabilities. As a non-limiting example, the suitcase comprises or is operably connected to a memory storage device, such as, for example, a USB. In additional embodiments, the suitcase comprises an interface for connecting the suitcase to a media platform. A media platform includes, without limitation, television, computer, tablet, phone, and any device capable of connecting to the internet. A media platform may include software configured for use with the suitcase. In other embodiments, the suitcase comprises an interface for connecting the suitcase to another product provided herein. In additional manifestations, the suitcase comprises an interface for connecting the suitcase to a power supply.

The suitcase, in various embodiments, has wireless data transmission capabilities. As a non-limiting example, the suitcase comprises Bluetooth or a Bluetooth adaptor. In some embodiments, a suitcase is connected to a media platform by Bluetooth. In some embodiments, the suitcase is connected to another product provided herein via Bluetooth.

In some embodiments, the suitcase further comprises one or more design elements. In some instances, a design element includes images portrayed on the suitcase which are not light generating elements. In some instances, the images correspond to one or more display elements. For example, the design element is the shape of the suitcase. For example, the suitcase is shaped as a car. The suitcase is configured to comprise any shape while maintaining function. In some embodiments, the shape is functional, i.e. it facilitates use by a child, and/or is for entertainment. In some instances, the design element includes conveniences. The compartment for accommodating personal items, in some instances, is made of scratch-resistant material. In some instances, a design element includes the composition of the suitcase. In some instances, the suitcase is comprised of materials suitable for child use. In some embodiments, one or more components of the suitcase comprises plastic, bamboo, metal, fiberglass, rubber, glass, silicone or combinations thereof. The suitcase, or one or more components of the suitcase, may comprise plastic. The suitcase, or one or more components of the suitcase may comprise canvas.

Further provided herein is a method of using a suitcase comprising one or more display elements. In some instances, the method comprises using the suitcase to transport a child's personal belongings. In some instances, the method comprises using the display element to provide a child encouragement during a trip. In some instances, the method comprises using the display element to provide educational support during a trip. In some instances, the method comprises using the display element to provide entertainment.

A method of using a suitcase provided herein includes, (a) providing a suitcase comprising a compartment for accommodating personal items, one or more display elements, and one or more control elements; and (b) controlling the operation of the display element by manipulating the control element. In some embodiments, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method of using a suitcase further comprises attaching a component to the suitcase. As a non-limiting example, the component is wheels. In some instances, the wheels comprise one or more display elements. In some instances, the wheels may be detachable.

In some embodiments, the method further comprises using one or more additional products in combination with the suitcase. In some instances, the one or more additional products comprise one or more display elements. In some instances, the one or more additional products comprise one or more sound elements. Additional products include, for example, handle wraps, luggage tags, bungees, locks, travel case, or luggage strap. In some embodiments, an accessory is a book which correlates to the display and/or design elements of the suitcase. In some embodiments, an accessory is an application or software performed on a computer such as a cell phone or tablet.

### Utensils

Provided herein are utensils comprising (a) top portion, (b) a handle, and (c) one or more display elements. A utensil includes, but is not limited to, a pen, pencil, crayon, marker, paint brush, chalk; and toothbrush. In some embodiments, the utensil is one component. In some embodiments, the utensil comprises two or more components. In some instances, one component is a top portion, and another component is a detachable handle. In some instances, the top portion is configured for writing or drawing. In some instances, the top portion is configured for brushing teeth. The utensil comprises one or more display elements on any surface or component of the utensil. In some embodiments, the display element is a light generating element. In a non-limiting example, the light generating element is a light-emitting diode. In some instances, the utensil further comprises one or more sound elements. In some instances, a sound element corresponds to a display element.

The utensil further comprises a power source for powering the display of the display element. As an example, the power source is a battery. The battery may be housed in the handles of the utensil. In some instances, the battery is positioned so that a child is not able to remove said battery. In some embodiments, the battery further provides power for one or more sound elements.

The utensil further comprises one or more control elements for displaying/visualizing one or more display elements. In some embodiments, the control element provides the display element access to a power source. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position.

The utensil further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The utensil, in various embodiments, has memory storage capabilities. As a non-limiting example, the utensil comprises or is operably connected to a memory storage device, such as, for example, a USB. In additional embodiments, the utensil comprises an interface for connecting the utensil to a media platform. A media platform includes, without limitation, television, computer, tablet, phone, and any device capable of connecting to the internet. A media platform may include software configured for use with the utensil. In other embodiments, the utensil comprises an interface for connecting the utensil to another product provided herein. In additional manifestations, the utensil comprises an interface for connecting the utensil to a power supply.

The utensil, in various embodiments, has wireless data transmission capabilities. As a non-limiting example, the utensil comprises Bluetooth or a Bluetooth adaptor. In some embodiments, a utensil is connected to a media platform by Bluetooth. In some embodiments, the utensil is connected to another product provided herein via Bluetooth.

In some embodiments, the utensil further comprises one or more design elements. As a non-limiting example, a design element includes images portrayed on the utensil which are not light generating elements. In some instances, the images correspond to one or more display elements. As another example, a design element includes the shape of the utensil. For example, the handle is shaped as a car. The utensil is configured to comprise any shape while maintaining function. In some instances, the shape is functional, i.e. it facilitates use by a child, and/or the shape is for entertainment. In some instances, the design element includes safety features. In some instances, the writing portion comprises non-toxic ink. In some instances, a design element includes the composition of the utensil. The utensil may be comprised of materials suitable for use by a child. In some embodiments, one or more components of the utensil comprises plastic, bamboo, metal, fiberglass, rubber, glass, silicone or combinations thereof. In some embodiments, the utensil, or one or more components of the utensil, comprises plastic. In some embodiments, the utensil, or one or more components of the utensil, comprises metal. In some instances, the utensil, or one or more components of the utensil, comprises ink. In some instances, the utensil, or one or more components of the utensil, comprises graphite.

Further provided herein is a method of using a utensil comprising one or more display elements. In some embodiments, the method comprises using the utensil to teach a child to write or draw. In some embodiments, the method comprises using the utensil to teach a child to brush their teeth. In some embodiments, the method comprises using the display element to provide a child encouragement during writing or drawing. In some embodiments, the method comprises using the utensil to provide encouragement during tooth brushing. In some embodiments, the method comprises using the display element to provide educational support during use. In some embodiments, the method comprises using the display element to provide entertainment.

A method of using a utensil provided herein includes, providing a utensil comprising a top portion, one or more display elements, and one or more control elements; and controlling the operation of the display element by manipulating the control element. In some embodiments, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method of using a utensil further comprises attaching a component to the utensil. As an example, the component is a handle or a handle accessory. A handle accessory includes a gripping device configured to assist holding by a young child. In some instances, a handle accessory comprises one or more display elements. In some instances, the handle accessory is stretchable so that it fits tightly along the outer edge of the utensil. In some instances, the handle comprises at least one tab configured to engage the handle of a utensil, for retaining the handle accessory on the utensil. In some instances, the handle comprises a groove configured to engage with the at least one tab of the handle accessory, for retaining the handle accessory on the utensil.

In some embodiments, the method further comprises using one or more additional products, components, and/or accessories in combination with the utensil comprising the one or more display elements. Additional products include papers, books, easels, and accessories. In some instances, additional products comprise one or more display elements. In some instances, additional products comprise one or more sound elements. In some embodiments, an accessory is a book which correlates to the display and/or design elements of the utensil. In some embodiments, an accessory is an application or software program performed on a computer such as a cell phone or tablet.

### Easel

Provided herein are easels comprising (a) a surface having a front facing side and a back facing side, wherein the top facing side is configured for drawing; and (b) one or more display elements. In some embodiments, the easel is one component. In some embodiments, the easel comprises two or more components. In some embodiments, the easel comprises a surface and at least one latch, wherein the latch is configured to attach the easel onto a body. For example, the body is a table or surface suitable for holding the easel. In some embodiments, the easel comprises a surface and one or more legs. In some instances, the legs are removably attached to the surface. In some instances, the easel comprises 1, 2, 3, 4, 5, 6, 7, 8, or more legs. The easel comprises one or more display elements on any surface or component of the easel. In some embodiments, the display element is a light generating element. As a non-limiting example, the light generating element is a light-emitting diode. In some instances, the easel further comprises one or more sound elements. In some instances, a sound element corresponds to a display element.

The easel further comprises a power source for powering the display of the display element. As a non-limiting example, the power source is a battery. The battery may be housed at the back facing side of the surface. The battery may be housed in a leg. The battery may be positioned so that a child is not able to remove said battery. In some instances, the battery further provides power for one or more sound elements.

The easel further comprises one or more control elements for displaying one or more display elements. In some embodiments, the control element provides the display element access to a power source. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position.

The utensil further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The easel, in various embodiments, has memory storage capabilities. As a non-limiting example, the easel comprises or is operably connected to a memory storage device, such as, for example, a USB. In additional embodiments, the easel comprises an interface for connecting the easel to a media platform. A media platform includes, without limitation, television, computer, tablet, phone, and any device capable of connecting to the internet. A media platform may include software configured for use with the easel. In other embodiments, the easel comprises an interface for connecting the easel to another product provided herein. In additional manifestations, the easel comprises an interface for connecting the easel to a power supply.

The easel, in various embodiments, has wireless data transmission capabilities. As a non-limiting example, the easel comprises Bluetooth or a Bluetooth adaptor. In some embodiments, an easel is connected to a media platform by Bluetooth. In some embodiments, the easel is connected to another product provided herein via Bluetooth.

In some embodiments, the easel further comprises one or more design elements. A design element includes images portrayed on the easel which are not light generating elements. In some instances, the images correspond to one or more display elements. In some instances, the design element includes the shape of the easel or a component of the easel. For example, the surface is shaped as character. The easel is configured to comprise any shape while maintaining function. In some instances, the shape is functional, i.e. it facilitates use by a child, and/or the shape is for entertainment. In some instances, the design element includes safety features. The surface, in some instances, is BPA and/or BPS free. In some embodiments, the entire easel, including the legs, is BPA and/or BPS free. The surface, in some instances, is lead free. In some embodiments, the entire easel, including the legs, is lead free. The design element may include conveniences. The surface for accommodating food, in some instances, is washable. In some embodiments, the entire easel, including the legs, is dishwasher safe. A design element includes the composition of the easel. The easel may be comprised of materials suitable for child use. In some embodiments, one or more components of the easel comprises plastic, bamboo, metal, fiberglass, rubber, glass, silicone or combinations thereof. In some embodiments, the easel, or one or more components of the easel, comprises plastic. In some embodiments, the easel, or one or more components of the easel comprises wood. The wood may be finished so as not to generate splinters in a child. In some instances, the surface of the easel comprises a whiteboard. In some instances, the surface of the easel comprises a chalkboard. In some instances, the surface of the easel comprises paper.

Further provided herein is a method of using an easel comprising one or more display elements. In some embodiments, the method comprises using the easel for drawing. In some embodiments, the method comprises using the display element to provide a child encouragement while the child learns how to write or draw. In some embodiments, the method comprises using the display element to provide educational support. In some embodiments, the method comprises using the display element to provide entertainment.

A method of using an easel provided herein includes providing an easel comprising a surface having a front facing side for writing or drawing, one or more display elements, and one or more control elements; and controlling the operation of the display element by manipulating the control element. In some embodiments, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method of using an easel further comprises attaching a component to the easel. Components include, but are not limited to, a latch, leg, or easel accessory. An easel accessory includes paper.

In some embodiments, the method further comprises using one or more additional products in combination with the easel comprising the one or more display elements. Additional products include, pens, markers, chalk, and accessories. In some instances, additional products comprise one or more display elements. In some instances, additional products comprise one or more sound elements. In some embodiments, an accessory is a book which correlates to the display and/or design elements of the easel. In some embodiments, an accessory is an application or software program performed on a computer such as a cell phone or tablet.

### Puzzle

Provided herein are puzzles comprising a plurality of pieces, wherein each puzzle piece comprises (a) a top facing side comprising one or more images and (b) a back facing side; provided that one or more of the plurality of pieces comprises a display element. In some embodiments, a display element is visualized on the top facing side of a puzzle piece. In other embodiments, a display element is visualized on the back facing side of a puzzle piece. Each piece of the puzzle is configured to be connected with at least one other piece of the puzzle. In an exemplary embodiment, when one or more pieces of the puzzle are properly connected to another piece of the puzzle, a picture or a portion of a picture is visualized on the top facing surface of the puzzle. In this instance, each image on each piece of the puzzle provides a portion of a picture. The size and shape of each piece in the puzzle may be different or similar. In some embodiments, the puzzle comprises about or at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, or more pieces. In some embodiments, the puzzle comprises up to 10,000, up to 9,000, up to 8,000, up to 7,000, up to 6,000, up to 5,000, up to 4,000, up to 3,000, up to 2,000, or up to 1,000 pieces. In some embodiments, the puzzle comprises from about 6 to about 10,000 pieces, from about 6 to about 9,000 pieces, from about 6 to about 8,000 pieces, from about 6 to about 7,000 pieces, from about 6 to about 6,000 pieces, from about 6 to about 5,000 pieces, from about 6 to about 4,000 pieces, from about 6 to about 3,000 pieces, from about 6 to about 2,000 pieces, from about 6 to about 1,000 pieces, from about 6 to about 500 pieces, from about 6 to about 400 pieces, from about 6 to about 300 pieces, from about 6 to about 200 pieces, from about 6 to about 100 pieces, or from about 6 to about 50 pieces. In some embodiments, the puzzle is a traditional two-dimensional puzzle. In some embodiments, the puzzle is a three-dimensional puzzle. In other embodiments, the puzzle is a four-dimensional puzzle. In various implementations, the puzzle comprises a component for holding puzzle pieces, either when the pieces are connected or separate.

The puzzle comprises one or more display elements on any surface or component of the puzzle, wherein a component includes a puzzle piece. In some embodiments, the display element is a light generating element. As a non-limiting example, the light generating element is a light-emitting diode. In some instances, the puzzle further comprises one or more sound elements. In some instances, a sound element corresponds to a display element.

One or more display elements of the puzzle, in various embodiments, are activated upon the connection of two puzzle pieces. As a non-limiting example, a display element is activated upon successful connection of two adjacent puzzle pieces. As another non-limiting example, one or more display elements are activated upon complete connection of all puzzle pieces in the puzzle. In another example, one or more display elements are activated upon improper connection of one or more puzzle pieces. In the previous example, the display element is an indication that the puzzle pieces have not been correctly connected.

The puzzle further comprises a power source for powering the display of the display element. As a non-limiting example, the power source is a battery. The power source may be housed in one or up to all of the puzzle pieces in the puzzle. The power source may be housed in a component of the puzzle configured for holding the puzzle pieces. In one embodiment, a power source is housed in a platform which provides a surface for holding one or more puzzle pieces, provided that one or more puzzle pieces is physically touching the platform. The power source may be positioned so that a child is not able to remove said power source. In some instances, the power source further provides power for one or more sound elements.

The puzzle further comprises one or more control elements for displaying one or more display elements. In some embodiments, the control element provides the display element access to a power source. In some instances, the control element is a control switch configured to be in at least two positions: an open and a closed position, provided that when the switch is in the open position, visualization of one or more display elements is possible, and provided that when the switch is in the closed position, one or more display elements are not visualized. In some embodiments, the control switch is configured to be in one or more intermediate positions. In some embodiments, intermediate positions selectively display one or more display elements at each intermediate position. In some embodiments, intermediate positions adjust the intensity of visualization of the display element. In some embodiments, the control switch further controls the release of one or more sound elements by moving the switch to an open, closed, or an optional intermediate position.

The utensil further comprises one or more volume control elements for controlling one or more sound elements. In some embodiments, the control element provides the display element access to a power source. In some instances, the volume control element is a control switch configured to be in at least two positions: a soft volume option and a loud volume option. In some embodiments, the volume control element is configured to be in one or more intermediate positions. In some embodiments, intermediate positions provide sound output of differing volume levels. In some embodiments, the volume control element further controls the release of one or more sound elements by moving the switch to an open, closed, or an optional intermediate position.

The puzzle comprises one or more design elements. A design element includes images visualized on the puzzle which are not light generating elements. In some instances, the images correspond to one or more display elements. In some instances, the design element includes the shape of the puzzle or a component or piece of the puzzle. For example, the surface of the puzzle, with all pieces correctly connected, is shaped as character. In some instances, the puzzle, when all pieces are correctly connected, has a two-dimensional or three-dimensional shape. The puzzle is configured to comprise any shape while maintaining connections between each puzzle piece. In some instances, the shape is functional, i.e. it facilitates use by a child, and/or the shape is for entertainment. In some instances, the design element includes safety features. The puzzle, in some instances, is lead free. In some embodiments, the puzzle is BPA and/or BPS free. The design element may include conveniences. A design element includes the composition of the puzzle. The puzzle may be comprised of materials suitable for child use. In some embodiments, one or more components of the puzzle comprises plastic, bamboo, metal, fiberglass, rubber, glass, silicone or combinations thereof. In some embodiments, the puzzle, or one or more components of the puzzle, comprises plastic. In some embodiments, the puzzle, or one or more components of the puzzle comprises wood. The wood may be finished so as not to generate splinters in a child.

The puzzle, in various embodiments, has memory storage capabilities. As a non-limiting example, the puzzle comprises or is operably connected to a memory storage device, such as, for example, a USB. In additional embodiments, the puzzle comprises an interface for connecting the puzzle to a media platform. A media platform includes, without limitation, television, computer, tablet, phone, and any device capable of connecting to the internet. A media platform may include software configured for use with the puzzle. In other embodiments, the puzzle comprises an interface for connecting the puzzle to another product provided herein. In additional manifestations, the puzzle comprises an interface for connecting the puzzle to a power supply.

The puzzle, in various embodiments, has wireless data transmission capabilities. As a non-limiting example, the puzzle comprises Bluetooth or a Bluetooth adaptor. In some embodiments, a puzzle is connected to a media platform by Bluetooth. In some embodiments, the puzzle is connected to another product provided herein via Bluetooth.

Further provided herein is a method of using a puzzle comprising one or more display elements. In some embodiments, the method comprises connecting one or more puzzle pieces to one or more additional puzzle pieces. In some embodiments, the method comprises using the display element to provide a child encouragement while the child learns to connect each piece of the puzzle together. In some embodiments, the method comprises using the display element to provide educational support. In some embodiments, the method comprises using the display element to provide entertainment.

A method of using a puzzle provided herein includes providing a puzzle comprising a plurality of puzzle pieces, one or more display elements, and one or more control elements; and controlling the operation of the display element by manipulating the control element. In some embodiments, manipulating the control element comprises positioning the control switch to an open or closed position. In some embodiments, manipulating the control element comprises positioning the control switch to an intermediate position. In some embodiments, the control switch is manipulated to release one or more sound elements. In some instances, there is a separate control switch for a display element and for a sound element.

In some embodiments, the method further comprises using one or more additional products in combination with the puzzle comprising the one or more display elements. Additional products include media (e.g., television), games, toys and books. In some instances, additional products comprise one or more display elements. In some instances, the additional products comprise one or more sound elements. In some embodiments, an accessory is a book which correlates to the display and/or design elements of the puzzle. In some embodiments, an accessory is an application or software program performed on a computer such as a cell phone or tablet.

1.-170. (canceled)

171. A product comprising:
a) a platform comprising a top facing surface and a bottom facing surface;
b) one or more light generating elements visible on the top facing surface of the platform;
c) a control element for controlling a display of the one or more light generating elements on the top facing surface of the platform; and
d) a power source to power the display of the one or more light generating elements;
provided that the top facing surface and the bottom facing surface define a housing for the one or more light generating elements.

172. The product of claim 171, further comprising one or more sound elements.

173. The product of claim 172, provided that a unique light generating element is paired with a unique sound element to form a unique sensory pair.

174. The product of claim 171, provided that the product comprises two or more light generating elements; and provided that one of the two or more light generating elements is visible on the top facing surface at a different time than another of the two or more light generating elements to provide a dynamic display.

175. The product of claim 171, provided that the control element comprises an on position and an off position; and provided that the on position optionally comprises two or more configurations for displaying the one or more light generating elements at variable intensities.

176. The product of claim 171, further comprising one or more activation elements that correspond to each light generating element; provided that each activation element comprises a mechanical element having a first configuration and a second configuration; and provided that the display of the one or more light generating elements is customizable by positioning one or more of the activation elements from the first configuration to the second configuration.

177. The product of claim 171, provided that the product is a plate; provided that the platform comprises a central area that accommodates food and an outer rim; and provided that one or more of the one or more light generating elements is visible on the top facing surface of the outer rim, the central area, or any region on the top facing surface of the plate.

178. The product of claim 171, provided that the product is a table, easel, highchair tray, stroller tray, or a combination thereof.

179. The product of claim 171, further comprising a latch configured to attach the platform to an external body.

180. The product of claim 171, further comprising a memory storage.

181. A vessel comprising:
a) a hollow body defining an inner space for holding food;
b) one or more light generating elements;
c) a control element for controlling a display of the one or more light generating elements; and
d) a power source to power the display of the one or more light generating elements.

182. The vessel of claim 181, further comprising
a) a detachable base; provided that the display of the one or more light generating elements is visible on the detachable base;
b) an outer rim, optionally attached to an outer edge of the hollow body; provided that the outer rim comprises at least one of the one or more light generating elements; and provided that the display of the one or more light generating elements is visible on the outer rim; or
c) the detachable base and the outer rim.

183. The vessel of claim 181, further comprising a lid, optionally attached to an outer edge of the hollow body; provided that the lid comprises at least one of the one or more light generating elements; and provided that the display of the one or more light generating elements is visible on the lid.

184. The vessel of claim 183, provided that the lid comprises a spout, nipple, or straw.

185. The vessel of claim 181, provided that the vessel comprises or is removably attached to a handle.

186. The vessel of claim 181, further comprising a memory storage.

187. A dining set comprising
a) the product of claim 171, provided that the product is a plate;
b) a vessel comprising: a hollow body defining an inner space for holding food, a vessel light generating element, and a vessel control element for controlling a vessel display of the vessel light generating element; and
c) a utensil comprising: a top portion for holding food, a handle comprising a utensil light generating element, and a utensil control element for controlling a utensil display of the utensil light generating element;
provided that at least one of the plate, vessel and utensil further comprise a sound element, a memory storage, or a combination thereof.

188. A training toilet comprising:
a) a seat having an opening for receiving bodily waste, the seat comprising a top facing surface and a toilet bowl facing surface, provided that the seat is optionally attached to a lid;
b) a toilet bowl positioned beneath the seat in contact with the toilet bowl facing surface of the seat, the toilet bowl comprising a hollow body defining an inner space for collecting a bodily waste; provided that the hollow body comprises a first surface in contact with the bodily waste and a second surface opposite the first surface;
c) one or more light generating elements visible on the second surface of the toilet bowel, the top facing surface of the seat, the optional lid, or a combination thereof;
d) one or more sound elements;
e) a control element for controlling a display of the one or more light generating elements; a sound emission from the one or more sound elements; or a combination thereof; and
f) a power source to power the display of the one or more light generating elements; the emission of the one or more sound elements; or a combination thereof.

189. The training toilet of claim 188, further comprising a display sensor; provided that at least one of the one or more light generating elements is activated for visualization by the display sensor.

190. The training toilet of claim 189, provided that the display sensor is configured to recognize the presence of a body on the top facing surface of the seat, the presence of bodily waste, or a combination thereof, to activate display of the one or more light generating elements.
